(19) United States
(12) Patent Application Publication
(10) Pub. No.: US 2009/0280054 A1
(43) Pub. Date: Nov. 12, 2009

(54) COMPOSITION AND PROCESS FOR THE DISPLACEMENT OF HYDROGEN FROM WATER UNDER STANDARD TEMPERATURE AND PRESSURE CONDITIONS

(76) Inventors: John J. Parker, Mount Laurel, NJ (US); Alfonso L. Baldi, Jupiter, FL (US)

Correspondence Address: CONNOLLY BOVE LODGE & HUTZ LLP, 1875 EYE STREET, N.W., SUITE 1100, WASHINGTON, DC, 20006, US

(21) Appl. No.: 12/397,698

(22) Filed: Mar. 4, 2009

Related U.S. Application Data
(60) Provisional application No. 61/068,212, filed on Mar. 5, 2008.

(51) Int. Cl. C01B 3/08; C09K 3/00; B01J 27/138; B01J 27/20

(52) U.S. Cl. 423/657; 252/182.32; 252/182.35; 502/226; 502/174; 252/182.33

(57) ABSTRACT

The present invention relates to the production of hydrogen. More particularly, the present invention relates to a composition and process for the displacement of hydrogen from water under standard temperature and pressure conditions. The composition comprises finely divided metal powders (e.g., magnesium, or magnesium and aluminum) and can also contain a chloride salt (e.g., sodium chloride or potassium chloride). The process of the present invention comprises adding a composition of the present invention to water (either water that already contains chloride ions—such as seawater—or, alternatively, with compositions that contain a chloride salt, either fresh water or seawater), at standard temperature and pressure conditions, in order to create hydrogen gas from the displacement of hydrogen from the water.

### BACKGROUND OF THE INVENTION

1. Field of the Invention

The present invention relates to the production of hydrogen. More particularly, the present invention relates to a composition and process for the displacement of hydrogen from water under standard temperature and pressure conditions. Although the present invention is suitable for a wide scope of applications, it is best suitable for applications requiring portability and mobility, or stationary applications when and where electricity (i.e., grid infrastructure) is unavailable.

2. Discussion of the Related Art

Hydrogen is commonly produced using various compositions and processes, the most common being autothermal reformation of hydrocarbons and electrolysis of water. Autothermal reformation of hydrocarbons presents a composition challenge because hydrocarbon impurities (e.g., sulfur compounds) and by-products (e.g., carbon monoxide, carbon dioxide) can pollute the environment; it presents a process challenge because the steam-reformation and partial oxidation reactions must be carried out at a very high temperature and pressure. Electrolysis of water presents a process challenge because the water decomposition reaction demands a very high electric current and potential difference.

Because the above compositions and processes for the production of hydrogen require the input of large amounts of electricity, either directly or indirectly in the form of heat, the above compositions and processes have a limited feasibility for applications requiring portability and mobility. Furthermore, the above compositions and processes have an obvious disadvantage when and where electricity (i.e., grid infrastructure) is unavailable. Considering the application-specific limitations and disadvantage of the above compositions and processes, only compositions and processes requiring minimum or zero input of electricity are discussed herein.

It is known to those skilled in the art that hydrogen can be produced by the reaction of an alkali metal or alkaline earth metal (except beryllium and magnesium) with water under standard temperature and pressure conditions. Alkali metals present a composition challenge because they are so reactive that they do not occur naturally in a free or uncombined state. Alkaline earth metals (except beryllium and magnesium) present a similar composition challenge because of their chemical instability under standard temperature and pressure conditions.

It is also known to those skilled in the art that hydrogen can be produced by the reaction of a metal (that is above hydrogen in the activity series of metals) with a dilute acid or the reaction of a metal (that is able to form an amphoteric hydroxide) with a dilute base under standard temperature and pressure conditions. Acids present a process challenge because they are corrosive and must be stored and disposed of in compliance with relevant laws and regulations. Bases present a similar process challenge because they are caustic.

The following related art examples claim compositions and processes for the production of hydrogen that substantially obviate one or more of the challenges due to limitations and disadvantages of the above compositions and processes. However, the following related art examples present new composition and process challenges due to inherent limitations and disadvantages.

An example of the related art is U.S. Pat. No. 6,534,033, wherein it is claimed that hydrogen can be produced by the reaction of a metal hydride with water, in the presence of a catalyst, under standard temperature and pressure conditions. This related art example presents a composition challenge because a stabilizing component (sodium hydroxide, lithium hydroxide, potassium hydroxide, sodium sulfide, thiourea, carbon disulfide, sodium zincate, sodium gallate, or mixtures thereof) is required to retard, impede, or prevent spontaneous decomposition of the metal hydride aqueous solution. Stabilized metal hydride aqueous solutions under standard temperature and pressure conditions are preferably maintained at a pH greater than 11 (more preferably at a pH greater than 13), making them highly caustic.

Another example of the related art is U.S. patent application Ser. No. 11/103,994 (published as US 2005/0232837 A1), wherein it is claimed that hydrogen can be produced by the reaction of a certain metal (preferably aluminum) with water, in the presence of a catalyst, under standard temperature and pressure conditions. This related art example presents composition challenges because the components are preferably pre-milled (to achieve mechanical alloying or plastic deformation) and the water is preferably pre-heated to an elevated temperature (greater than 55° C.). This related art example presents a process challenge because the production of hydrogen is uncontrolled.

### SUMMARY OF THE INVENTION

Accordingly, the present invention is directed to a composition and process for the displacement of hydrogen from water under standard temperature and pressure conditions that substantially obviate one or more of the challenges due to limitations and disadvantages of the related art.

An object of the present invention is to provide a composition for the displacement of hydrogen from water under standard temperature and pressure conditions that is chemically stable under standard temperature and pressure conditions.

A benefit and advantage of this object of the present invention is that the cost associated with transporting the provided composition is low, relative to a composition that is chemically unstable.

Another benefit and advantage of this object of the present invention is that the cost associated with storing the provided composition is low, relative to a composition that is chemically unstable.

Yet another benefit and advantage of this object of the present invention is that the cost associated with handling the provided composition is low, relative to a composition that is chemically unstable.

Another object of the present invention is to provide a composition for the displacement of hydrogen from water under standard temperature and pressure conditions that requires minimum or zero pre-treatment.

A benefit and advantage of this object of the present invention is that the cost associated with processing the provided composition is low, relative to a composition requiring extensive pre-treatment.

Another benefit and advantage of this object of the present invention is that the complexity of a process employing the provided composition is low, relative to a composition requiring extensive pre-treatment.

Yet another object of the present invention is to provide a composition for the displacement of hydrogen from water under standard temperature and pressure conditions that is environmentally benign and minimally corrosive or caustic.

A benefit and advantage of this object of the present invention is that the provided composition poses no serious threat to environmental health.

Another benefit and advantage of this object of the present invention is that the provided composition poses no serious threat to human health.

Yet another object of the present invention is to provide a process for the displacement of hydrogen from water under standard temperature and pressure conditions that requires minimum or zero input of electricity.

A benefit and advantage of this object of the present invention is that the provided process is suitable for applications requiring portability and mobility.

Another benefit and advantage of this object of the present invention is that the provided process is suitable for stationary applications when and where electricity (i.e., grid infrastructure) is unavailable.

Yet another benefit and advantage of this object of the present invention is that the cost associated with operating the provided process is low, relative to a process requiring extensive input of electricity.

Yet another object of the present invention is to provide a process for the displacement of hydrogen from water under standard temperature and pressure conditions that results in formation of environmentally benign by-products.

A benefit and advantage of this object of the present invention is that by-products of the provided process pose no serious threat to environmental health.

Another benefit and advantage of this object of the present invention is that the cost associated with disposing by-products of the provided process is low, relative to a process resulting in formation of environmentally hazardous by-products.

Yet another object of the present invention is to provide a process for the displacement of hydrogen from water under standard temperature and pressure conditions such that production of hydrogen may be controlled.

A benefit and advantage of this object of the present invention is that production of hydrogen in excess of usage requirement is low, relative to a process such that production of hydrogen may not be controlled.

If excess product (i.e., hydrogen) is to be stored for eventual use, then another benefit and advantage of this object of the present invention is that the cost associated with storing excess product is low, relative to a process such that production of hydrogen may not be controlled.

If excess product (i.e., hydrogen) is to be vented, then yet another benefit and advantage of this object of the present invention is that the cost associated with venting excess product is low, relative to a process such that production of hydrogen may not be controlled.

Yet another object of the present invention is to provide a process for the displacement of hydrogen from water under standard temperature and pressure conditions that results in the formation of salable by-products of high market value.

A benefit and advantage of this object of the present invention is that generation of waste by the provided process is low, relative to a process resulting in formation of unsalable by-products.

Another benefit and advantage of this object of the present invention is that the value-added by the by-products of the provided process is high, relative to a process resulting in formation of salable by-products of a lesser market value.

These and other objects of the present invention will become apparent to those skilled in the art upon examination of the following, or may be learned from practice of the present invention. To achieve the benefits and advantages in accordance with these and other objects of the present invention, as embodied and broadly described, a composition and process is provided for the displacement of hydrogen from water under standard temperature and pressure conditions.

In one aspect, the provided composition is finely divided magnesium that is chemically stable under standard temperature and pressure conditions. The provided process involves addition of the finely divided magnesium to water (seawater) under standard temperature and pressure conditions.

In another aspect, the provided composition is a mixture of finely divided magnesium and finely divided aluminum that is chemically stable under standard temperature and pressure conditions. The provided process involves addition of the mixture of finely divided magnesium and finely divided aluminum to water (seawater) under standard temperature and pressure conditions.

In yet another aspect, the provided composition is a mixture of finely divided sodium chloride and finely divided magnesium that is chemically stable under standard temperature and pressure conditions. The provided process involves addition of the mixture of finely divided sodium chloride and finely divided magnesium to water (tap, deionized, or seawater) under standard temperature and pressure conditions.

In yet another aspect, the provided composition is a mixture of finely divided sodium chloride, finely divided magnesium, and finely divided aluminum that is chemically stable under standard temperature and pressure conditions. The provided process involves addition of the mixture of finely divided sodium chloride, finely divided magnesium, and finely divided aluminum to water (tap, deionized, or seawater) under standard temperature and pressure conditions.

In all aspects, the production of hydrogen (rate and extent) may be further assisted by including a finely divided carbonyl iron, finely divided ferric oxide, or finely divided ferric-ferrous oxide (preferably supported on an inert substrate material) catalyst in the provided composition. The provided process may be controlled by separating the aforementioned catalyst from the other components of the provided composition, and varying the amount of contact between the aforementioned catalyst and the other components of the provided composition.

If the provided composition is finely divided magnesium or a mixture of finely divided sodium chloride and finely divided magnesium, and if it is subjected to the provided process under standard temperature and pressure conditions, then the product of the provided composition and process is hydrogen, and the by-product of the provided composition and process is magnesium hydroxide.

If the provided composition is a mixture of finely divided magnesium and finely divided aluminum or a mixture of finely divided sodium chloride, finely divided magnesium, and finely divided aluminum, and if it is subjected to the provided process under standard temperature and pressure conditions, then the product of the provided composition and process is hydrogen, and the by-product of the provided composition and process is a mixture of magnesium hydroxide and aluminum hydroxide.

The by-product of the provided composition and process (i.e., magnesium hydroxide or a mixture of magnesium hydroxide and aluminum hydroxide) is salable and of high market value. Precipitated aluminum hydroxide and/or magnesium hydroxide may be recovered from the process for sale or further process. Magnesium hydroxide and aluminum hydroxide are of high market value as raw materials for the production of some pharmaceuticals. Further processed (i.e., calcined) to form magnesium oxide and aluminum oxide, these by-products are of even higher market value as raw materials for the production of thermal and electrical insulation (i.e., refractory linings). The cost of the provided composition and process is offset by the value-added of these by-products, further lowering the already low cost of (and low cost associated with) the provided composition and process.

### BRIEF DESCRIPTION OF THE DRAWINGS

The accompanying drawings, which are incorporated into and constitute part of the specification, illustrate the preferred embodiments of the present invention, and, together with the foregoing description and examples, serve to explain the preferred embodiments of the present invention.

FIG. 1 is a data plot of temperature as a function of time, for finely divided magnesium of different particle sizes (for finely divided aluminum of a 40-325 mesh particle size), in support of Example 1.

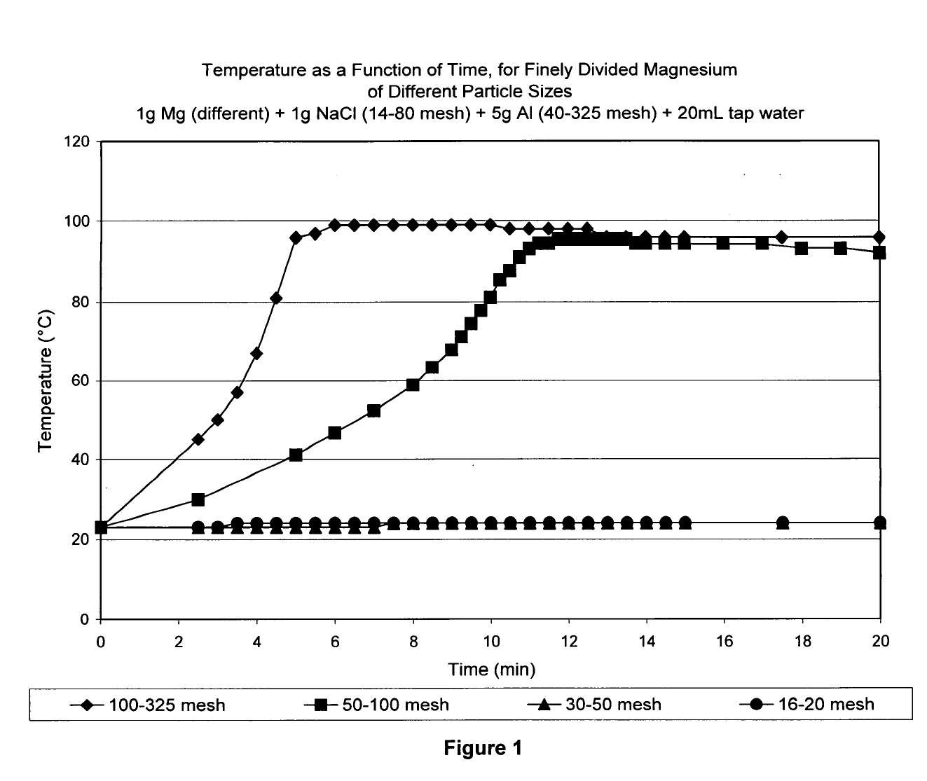

FIG. 2 is a data plot of temperature as a function of time, for finely divided aluminum of different particle sizes (for finely divided magnesium of a 100-325 mesh particle size), in support of Example 2.

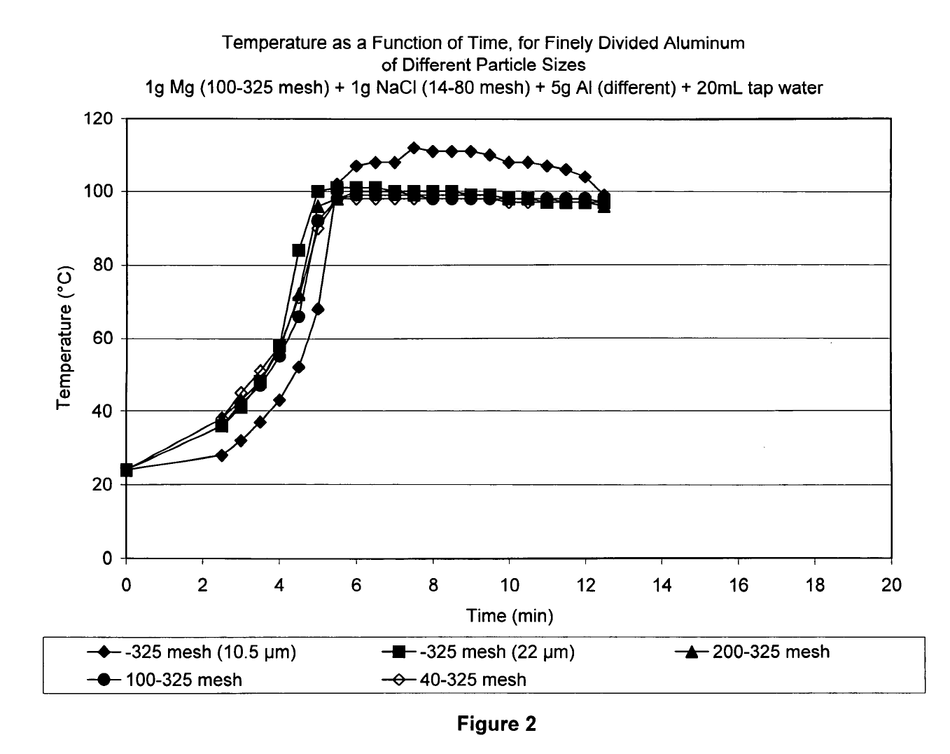

FIG. 3 is a data plot of temperature as a function of time, for finely divided aluminum of different particle sizes (for finely divided magnesium of a 50-100 mesh particle size), in support of Example 2.

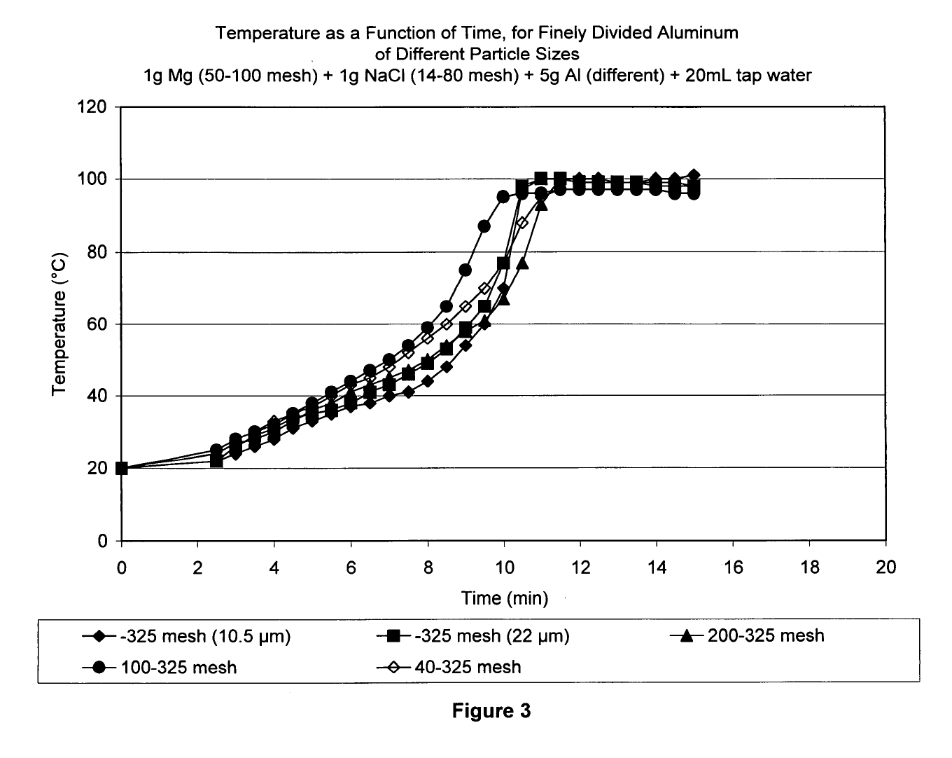

FIG. 4 is a data plot of temperature as a function of time, for different sodium chloride forms (for tap water), in support of Example 3.

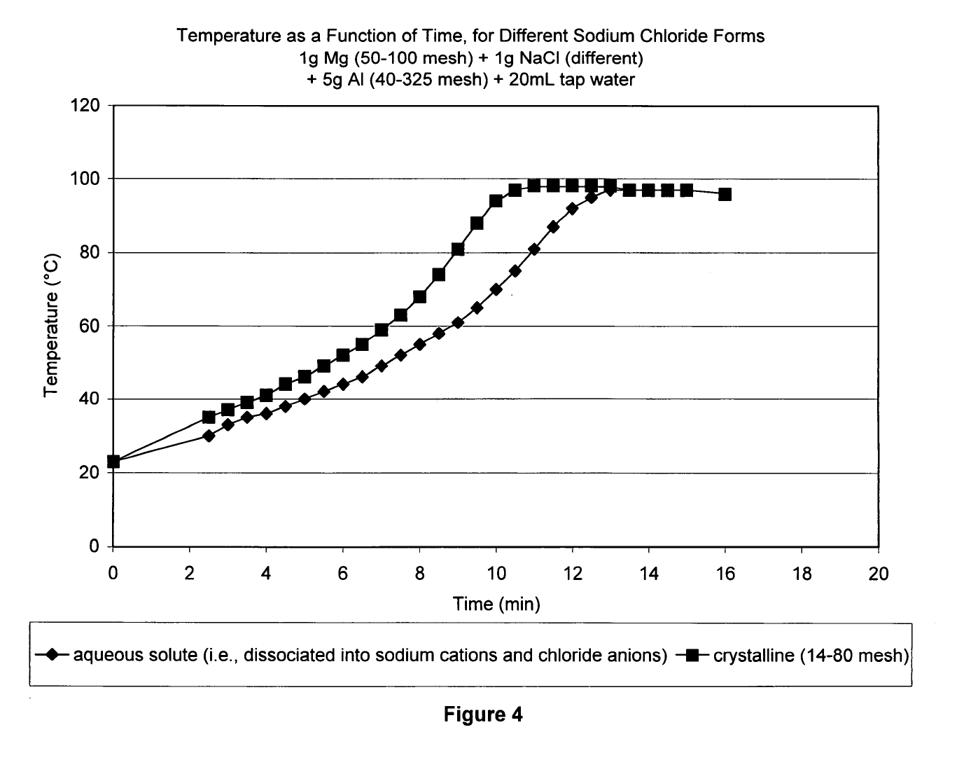

FIG. 5 is a data plot of temperature as a function of time, for different sodium chloride forms (for deionized water), in support of Example 4.

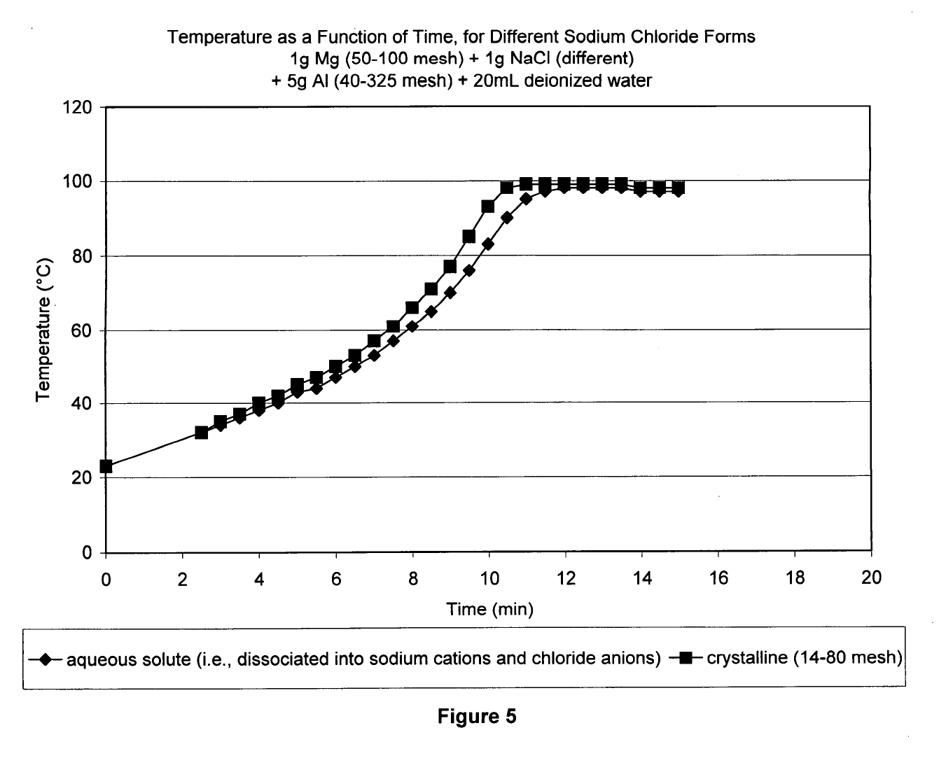

FIG. 6 is a data plot of temperature as a function of time, for different sodium chloride forms (for seawater), in support of Example 4.

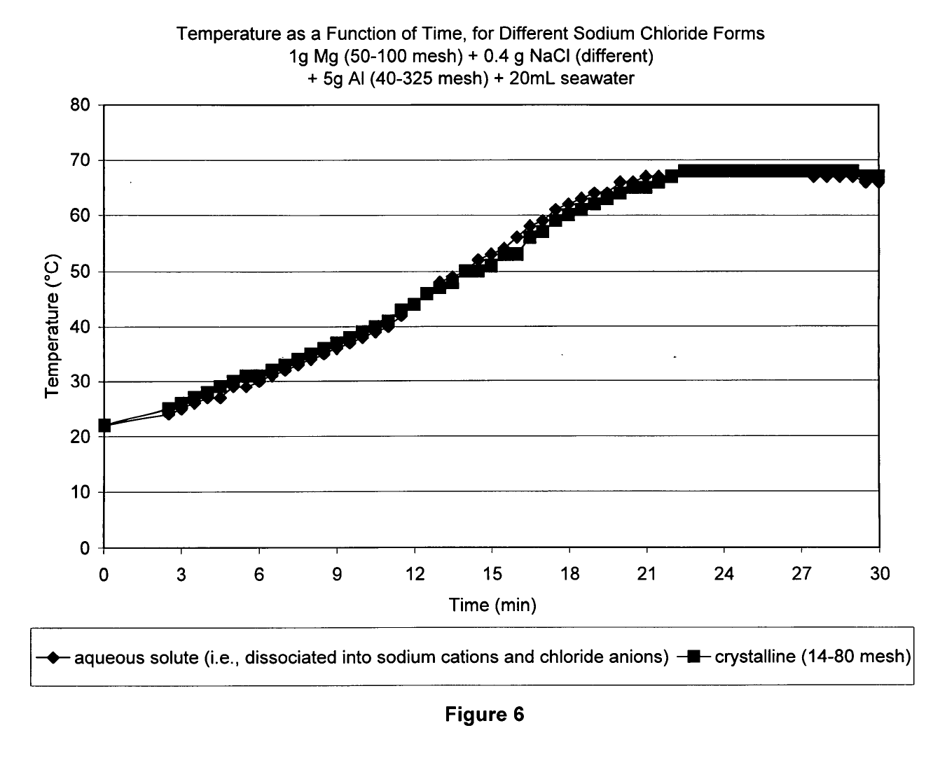

FIG. 7 is a data plot of temperature as a function of time, for different water type classifications, in support of Example 4.

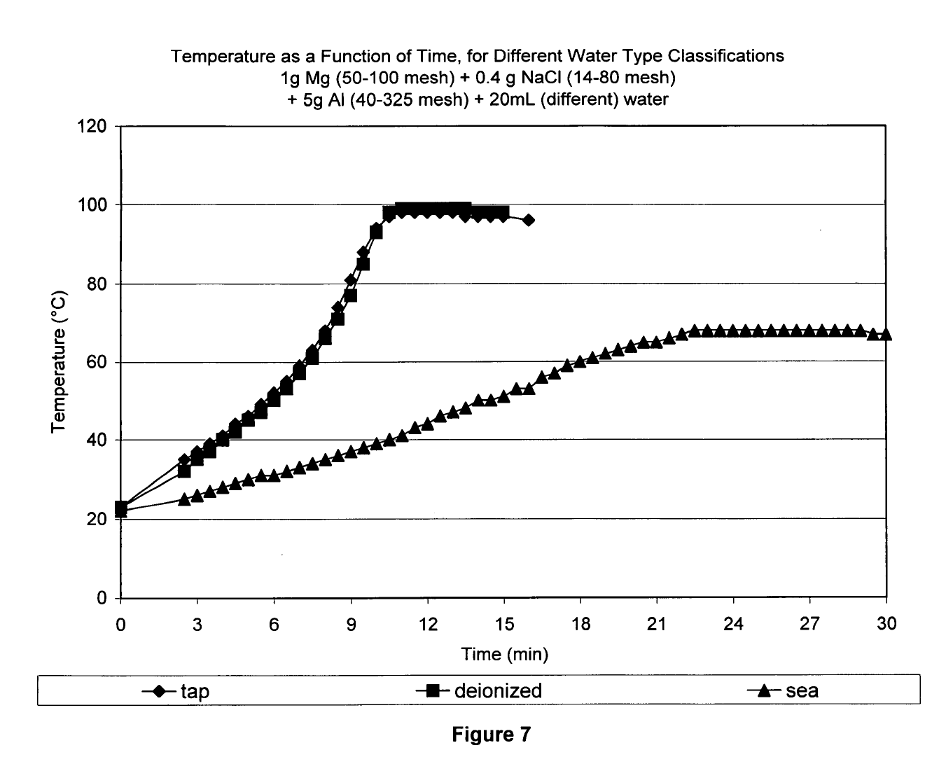

FIG. 8 is a data plot of time to reach maximum temperature as a function of magnesium to aluminum (w/w) ratio, in support of Example 5.

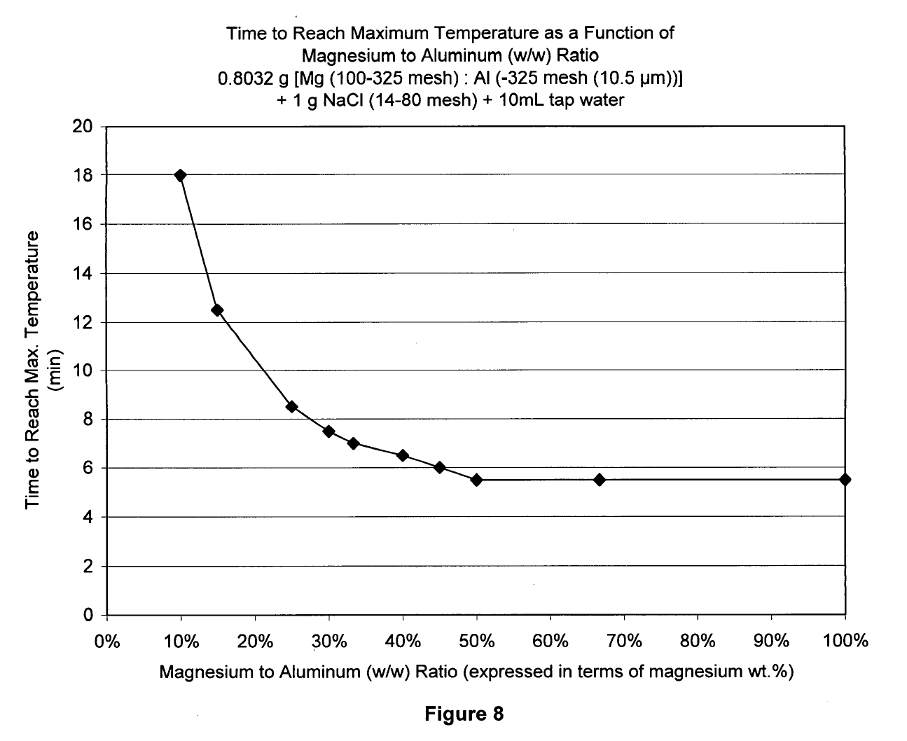

FIG. 9 is a data plot of volumetric yield (of hydrogen gas, after 20 minutes) as a function of magnesium to aluminum (w/w) ratio (for finely divided magnesium of a 100-325 mesh particle size), in support of Example 5.

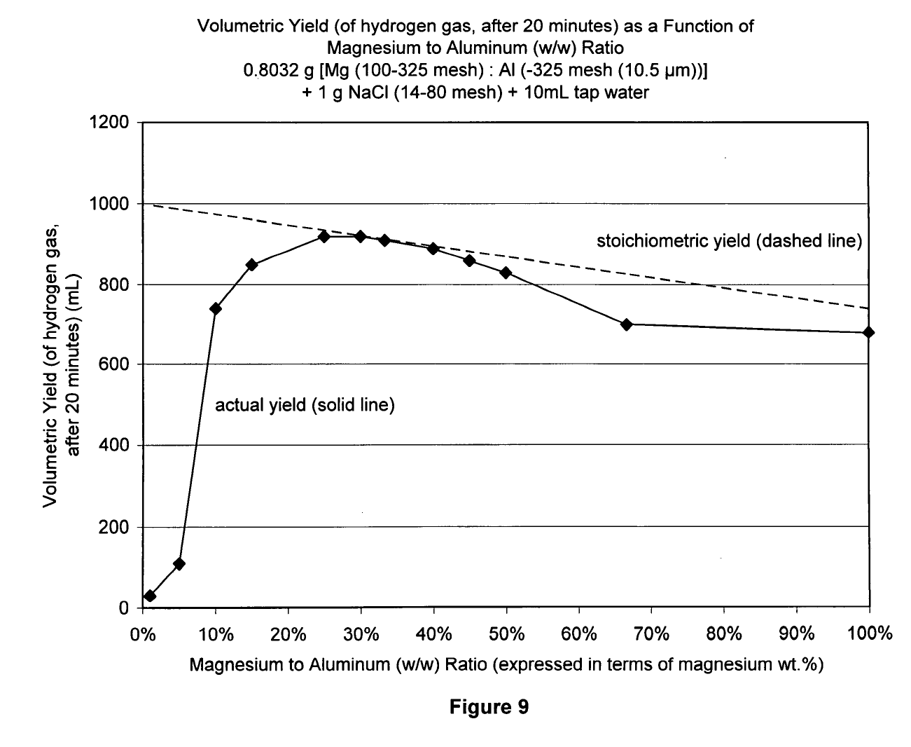

FIG. 10 is a data plot of volumetric yield (of hydrogen gas, after 1 hour) as a function of magnesium to aluminum (w/w) ratio (for finely divided magnesium of a 50-100 mesh particle size), in support of Example 5.

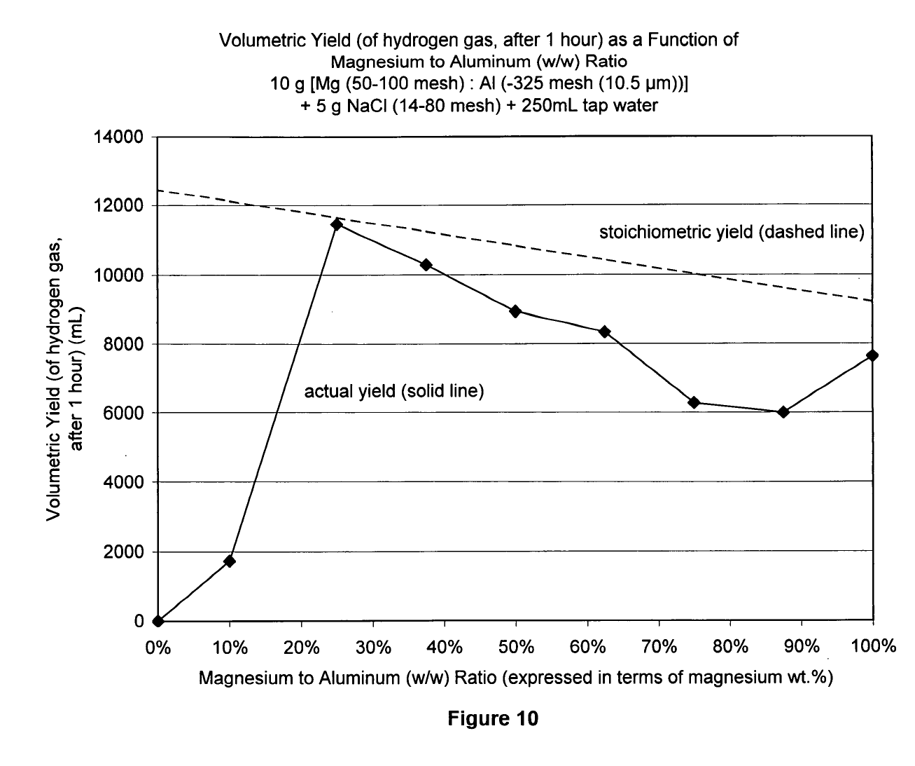

FIG. 11 is a data plot of volumetric yield (of hydrogen gas) as a function of time, for different magnesium to sodium chloride (w/w) ratios, in support of Example 6.

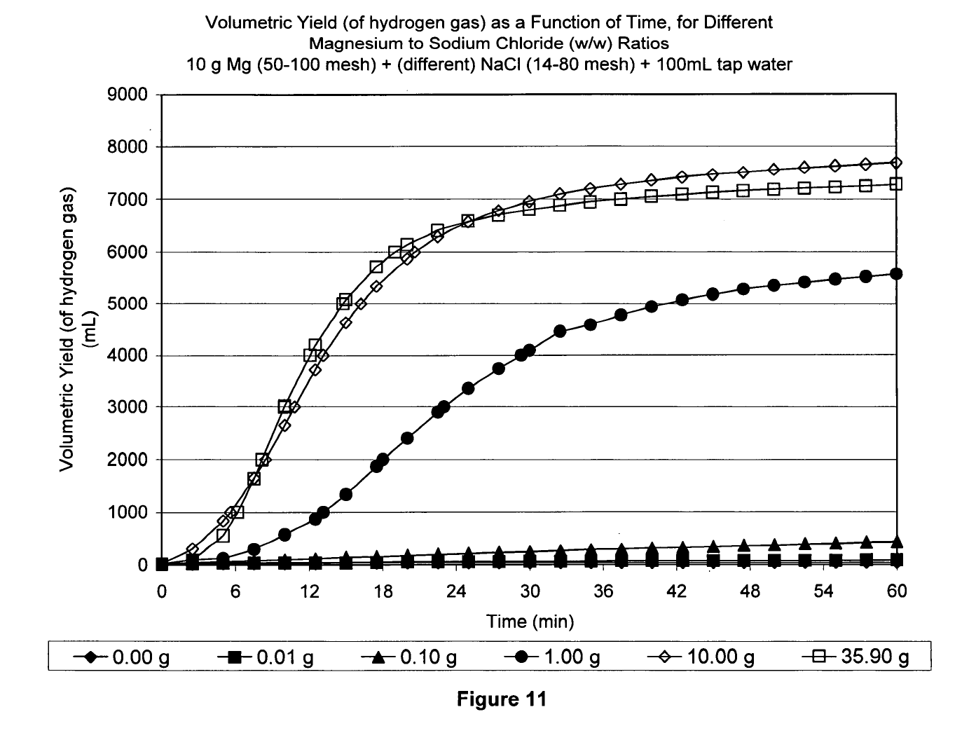

FIG. 12 is a data plot of volumetric rate of generation (of hydrogen gas) as a function of time, for different magnesium to sodium chloride (w/w) ratios, in support of Example 6.

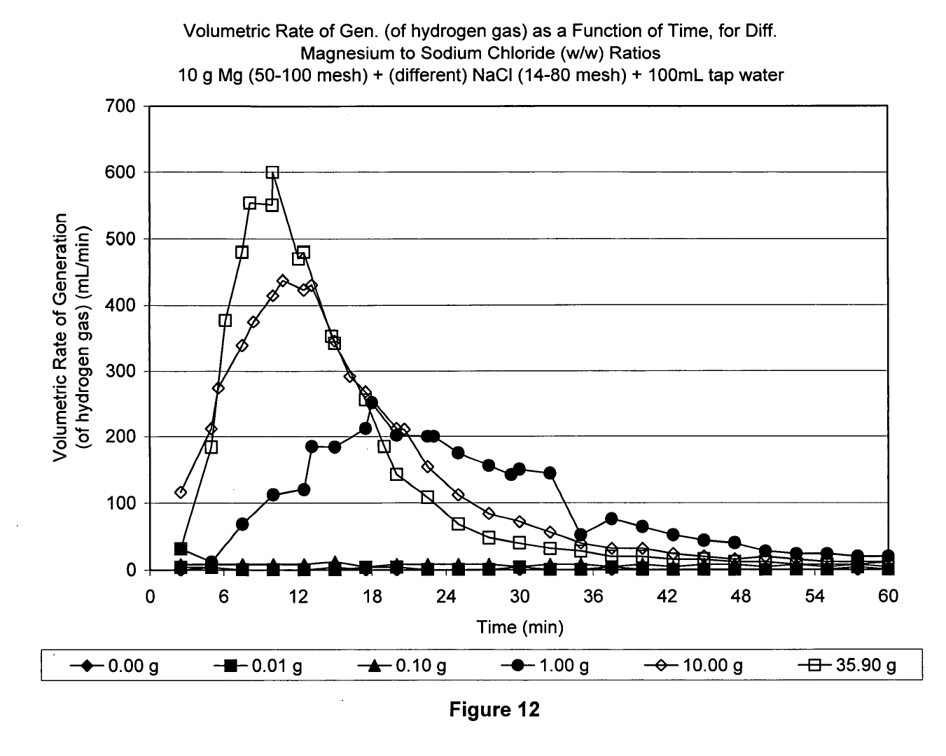

FIG. 13 is a data plot of volumetric yield (of hydrogen gas) as a function of time, for different magnesium to sodium chloride aqueous solution (w/w) ratios, in support of Example 7.

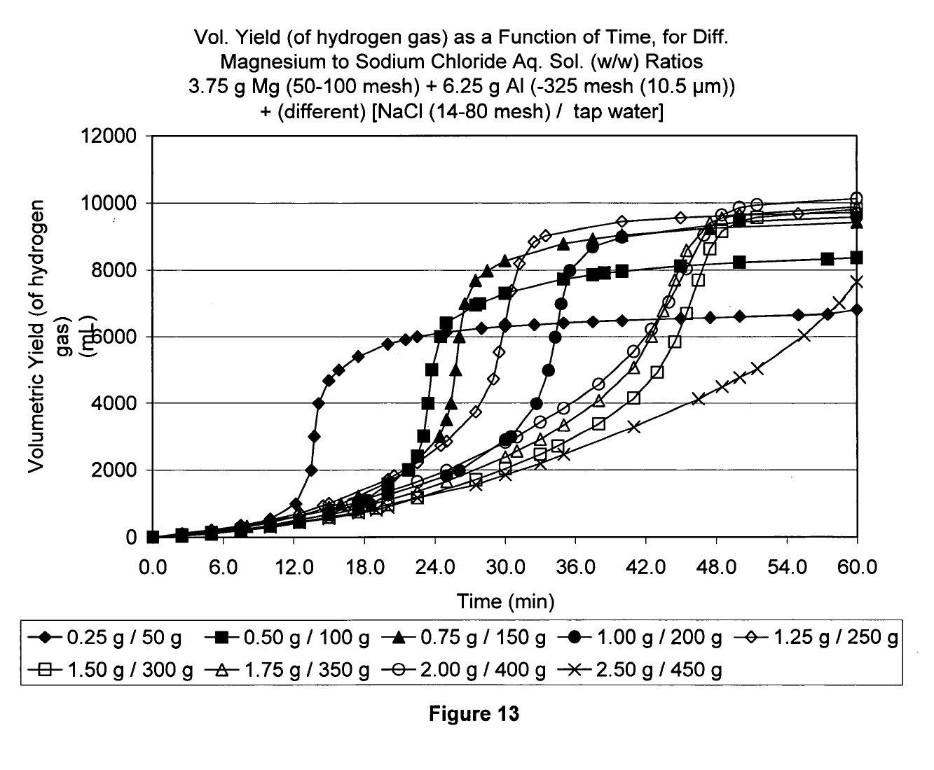

FIG. 14 is a data plot of volumetric rate of generation (of hydrogen gas) as a function of time, for different magnesium to sodium chloride aqueous solution (w/w) ratios, in support of Example 7.

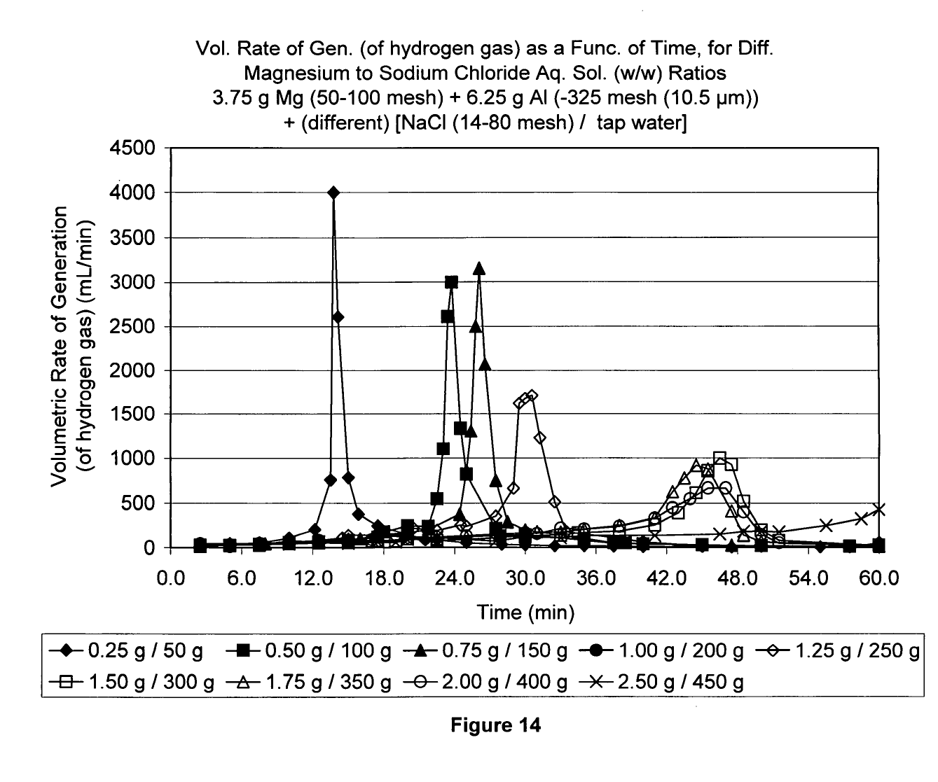

FIG. 15 is a data plot of volumetric yield (of hydrogen gas) as a function of time, for continuous agitation (versus no agitation) of reaction vessel contents, in support of Example 8.

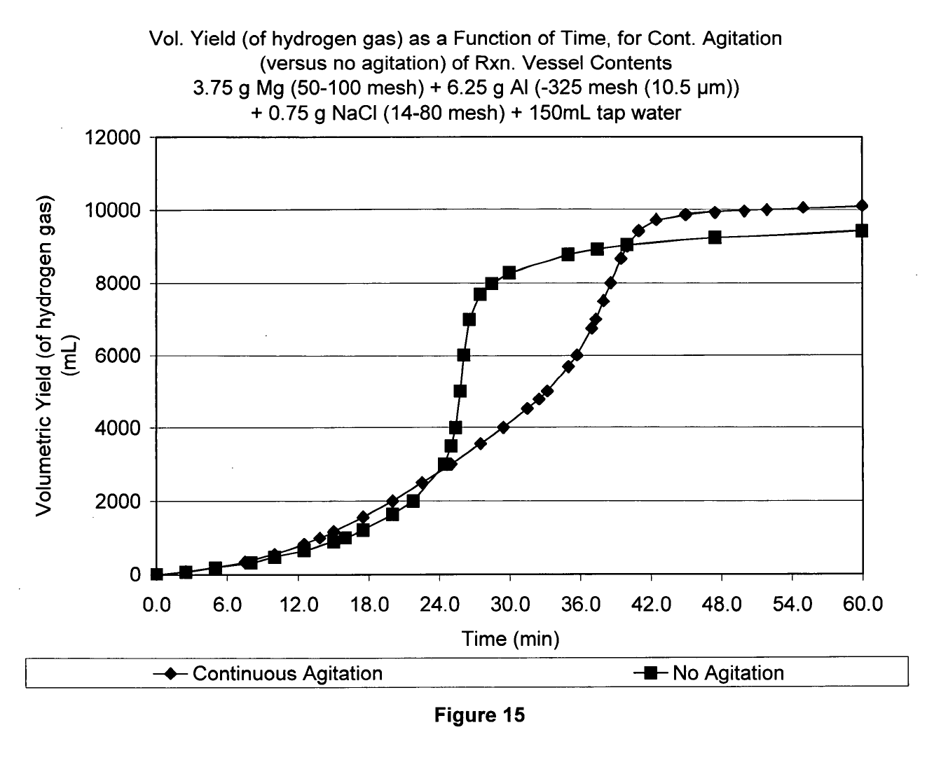

FIG. 16 is a data plot of volumetric rate of generation (of hydrogen gas) as a function of time, for continuous agitation (versus no agitation) of reaction vessel contents, in support of Example 8.

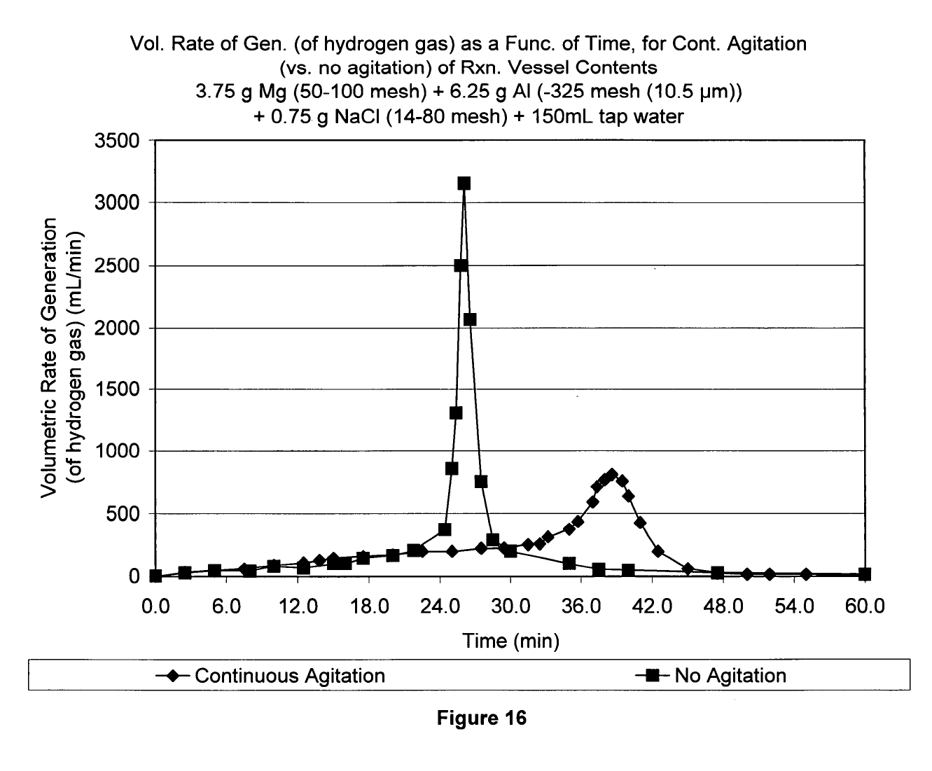

FIG. 17 is a data plot of volumetric yield (of hydrogen gas) as a function of time, for insulation (versus no insulation) of reaction vessel, in support of Example 9.

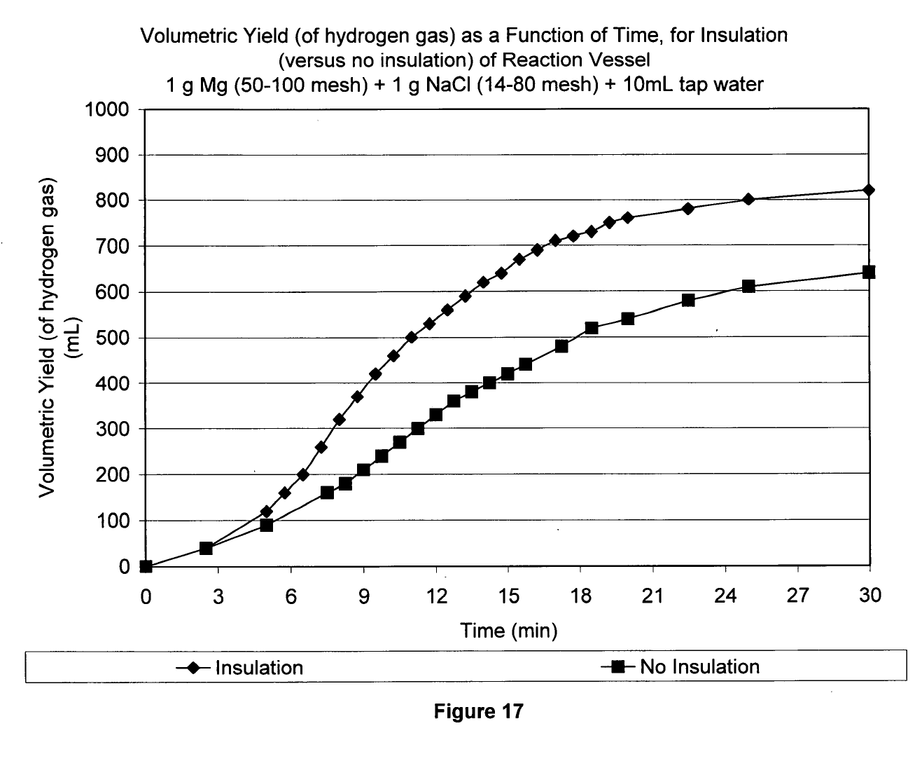

FIG. 18 is a data plot of volumetric rate of generation (of hydrogen gas) as a function of time, for insulation (versus no insulation) of reaction vessel, in support of Example 9.

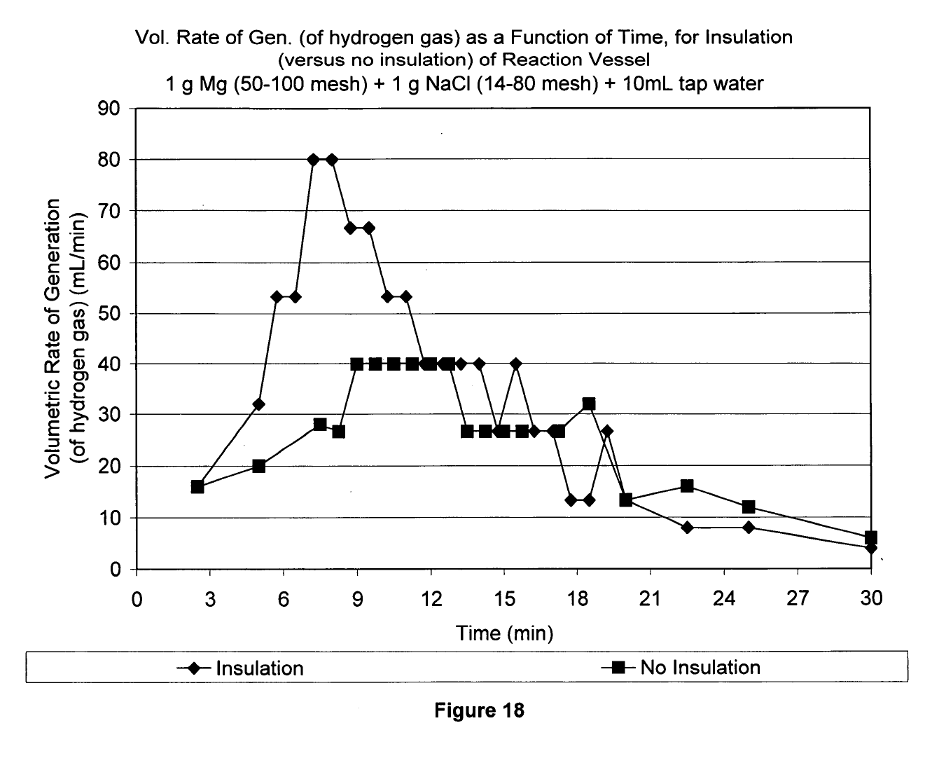

FIG. 19 is a data plot of temperature as a function of time, for insulation (versus no insulation) of reaction vessel, in support of Example 9.

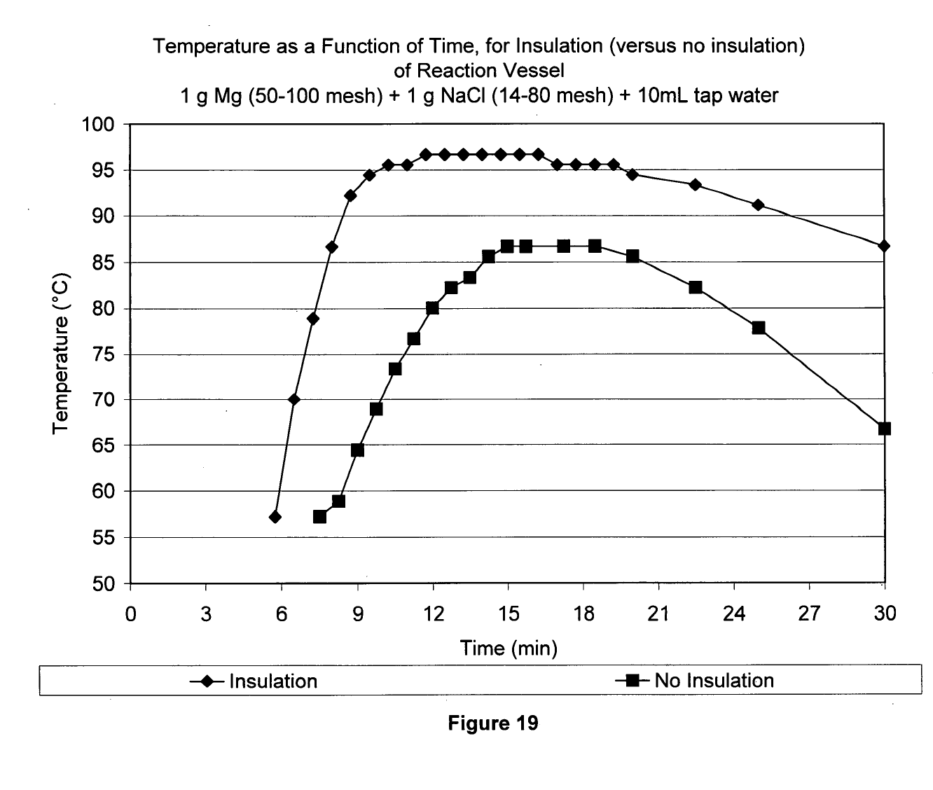

FIG. 20 is a data plot of temperature as a function of time, for inclusion of different catalyst (versus no catalyst), in support Example 10 and Example 11.

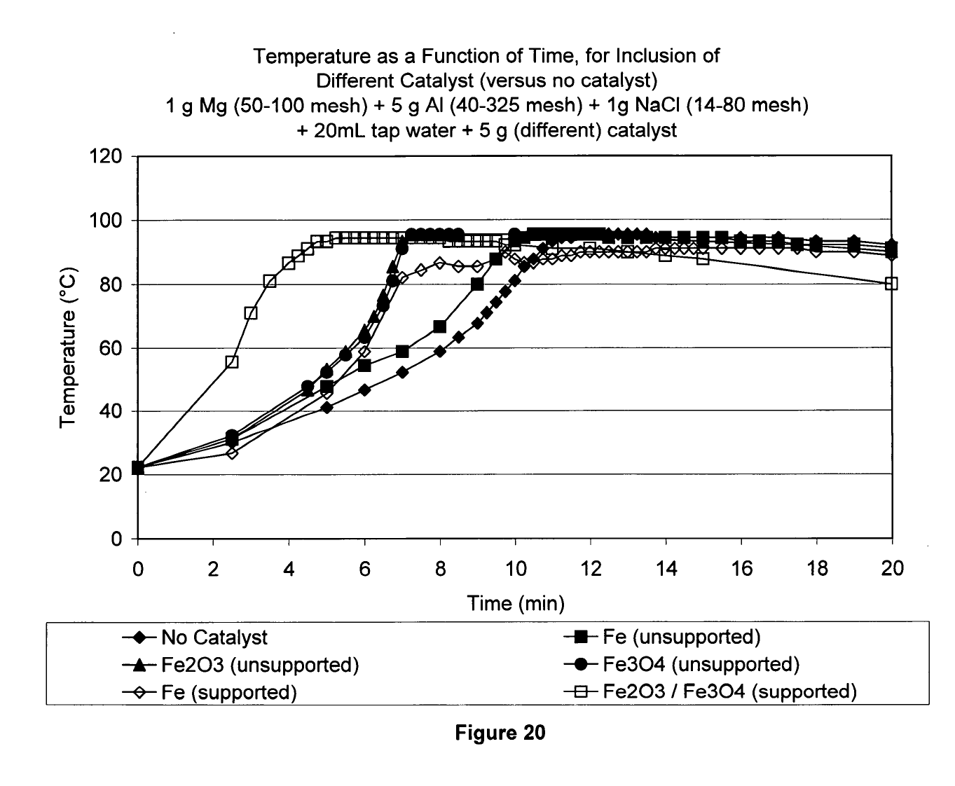

FIG. 21 is a data plot of temperature as a function of time, for inclusion of different masses of passivated supported catalyst (versus no catalyst), in support of Example 12.

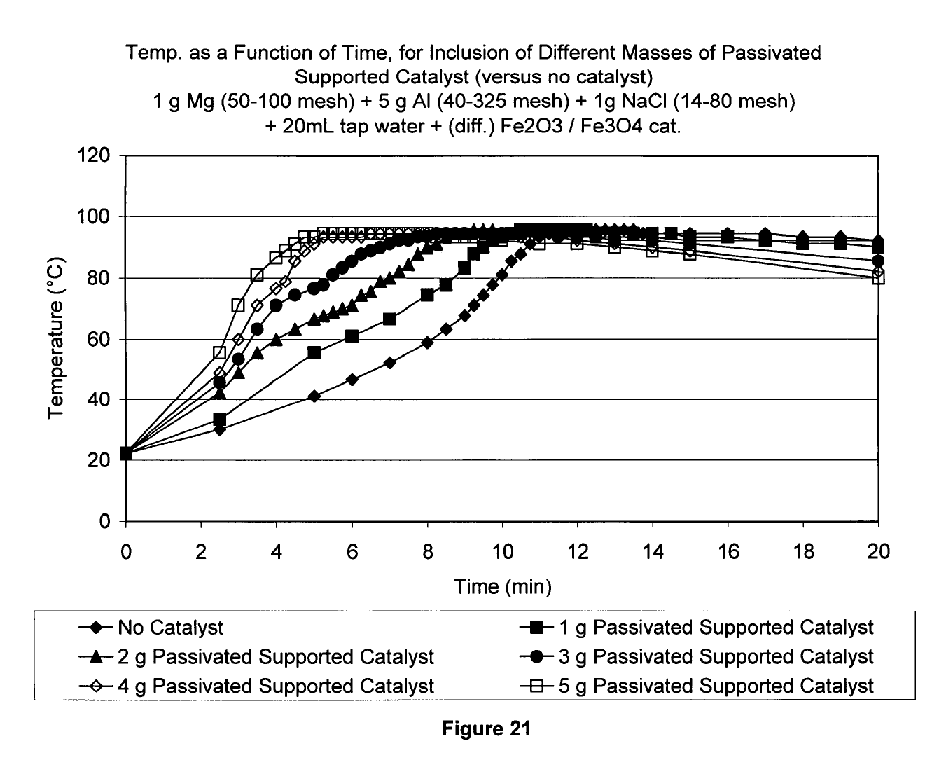

FIG. 22 is a data plot of volumetric yield (of hydrogen gas) as a function of time, for different salt chemistries, in support of Example 13.

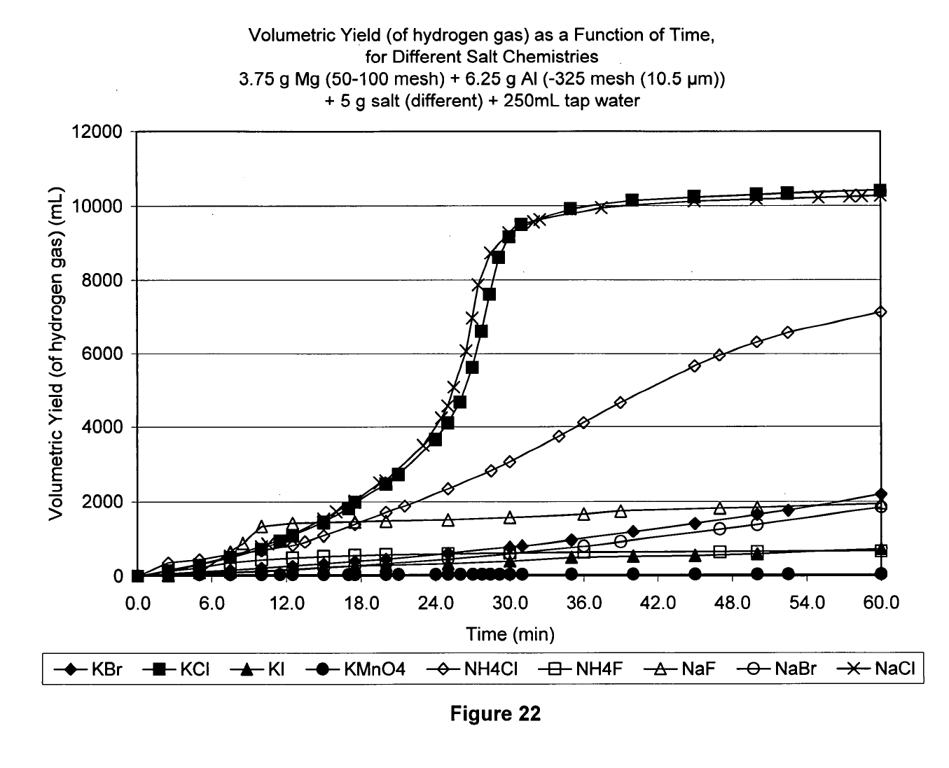

FIG. 23 is a data plot of volumetric rate of generation (of hydrogen gas) as a function of time, for different salt chemistries, in support of Example 13.

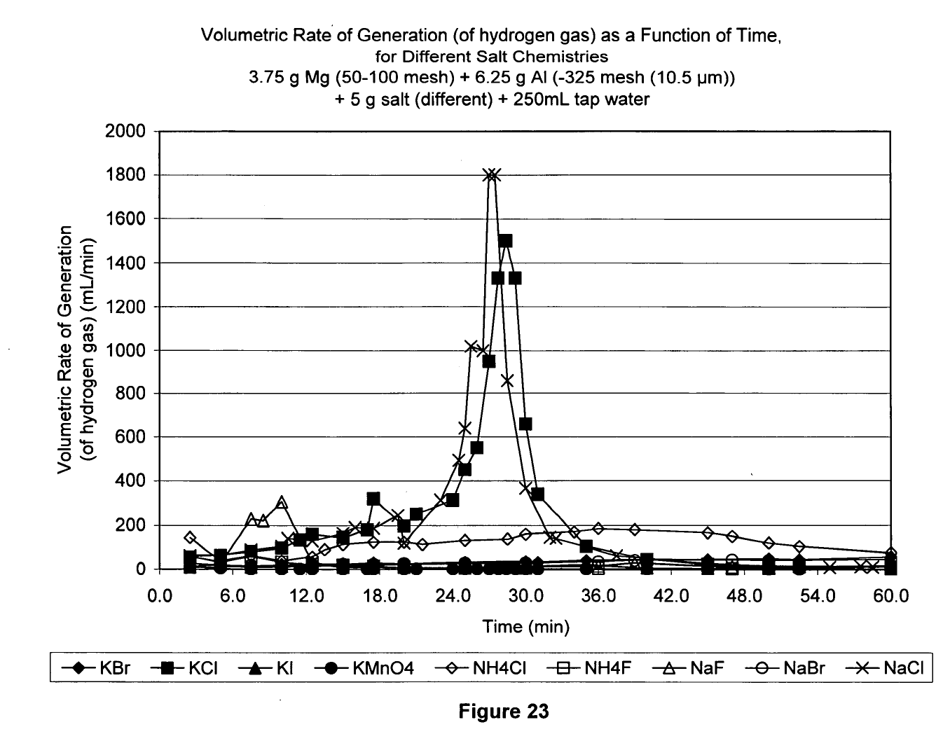

FIG. 24 is a data plot of temperature as a function of time, for different reaction vessel scaling, in support of Example 14.

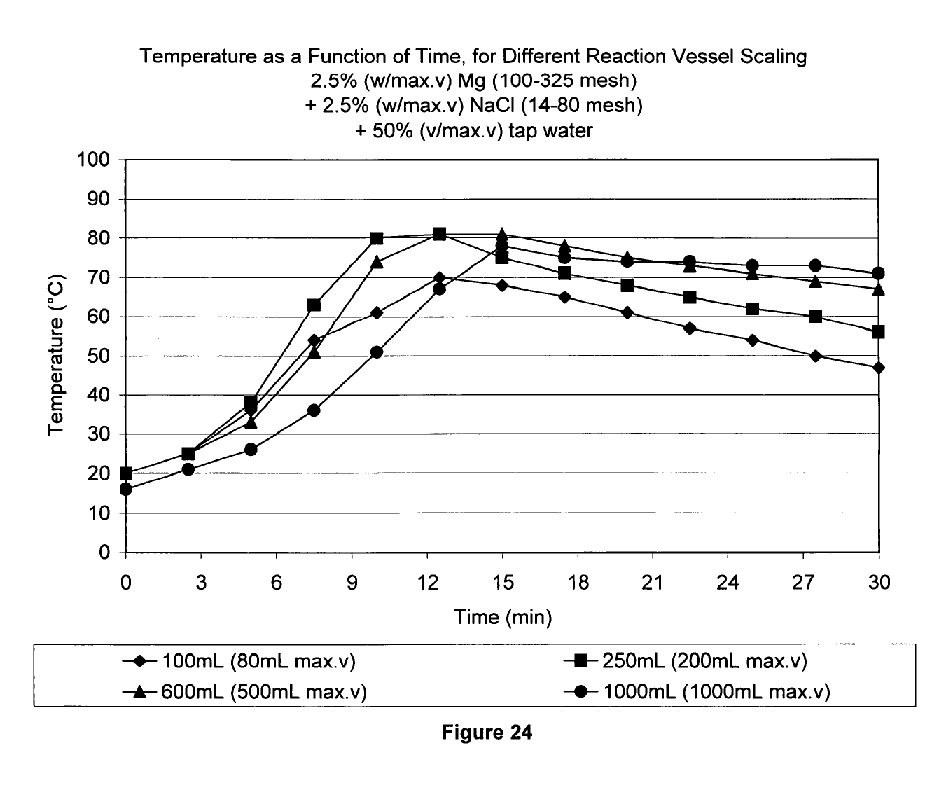

FIG. 25 is a data plot of volumetric yield (of hydrogen gas) as a function of time, for different metals (in lieu of aluminum), in support of Example 15.

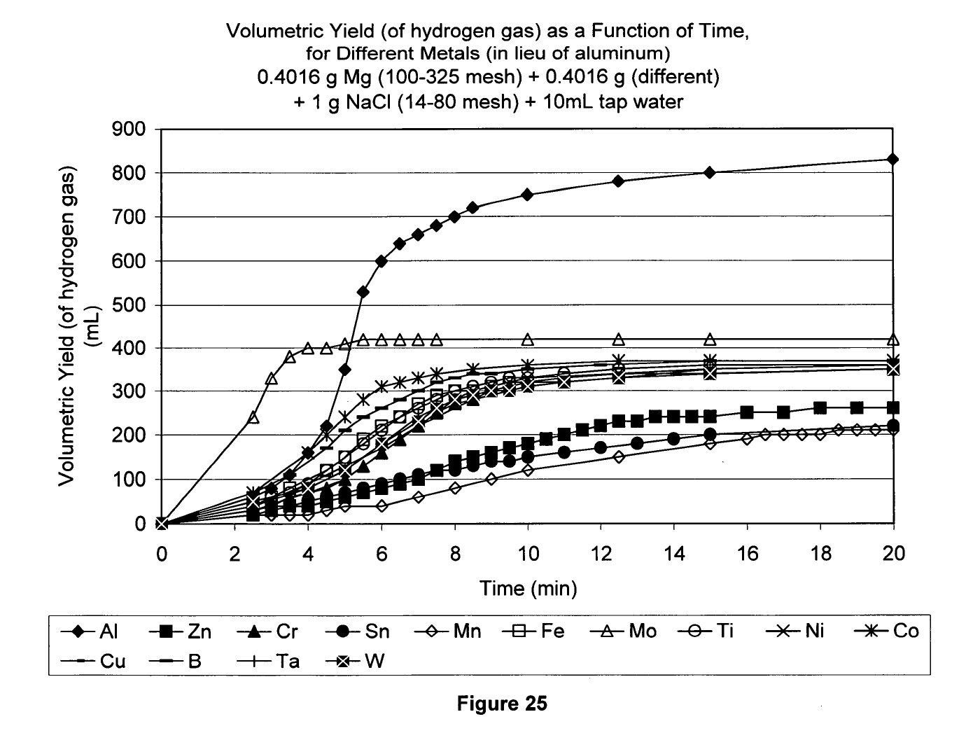

FIG. 26 is a data plot of volumetric rate of generation (of hydrogen gas) as a function of time, for different metals (in lieu of aluminum), in support of Example 15.

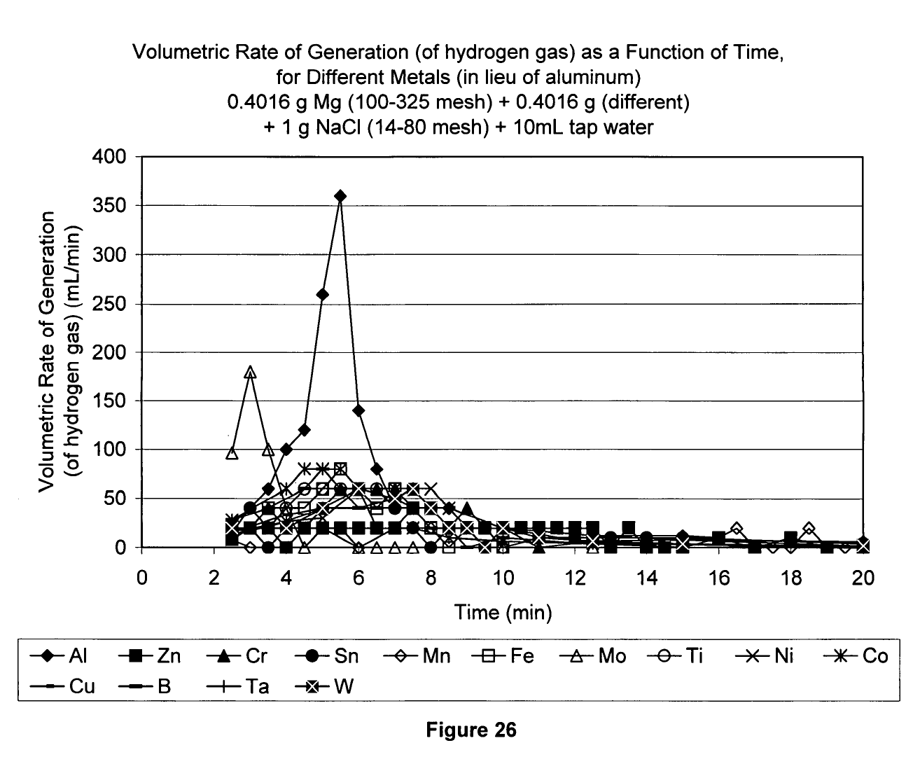

FIG. 27 is a data plot of temperature as a function of time, for different metals (in lieu of aluminum), in support of Example 15.

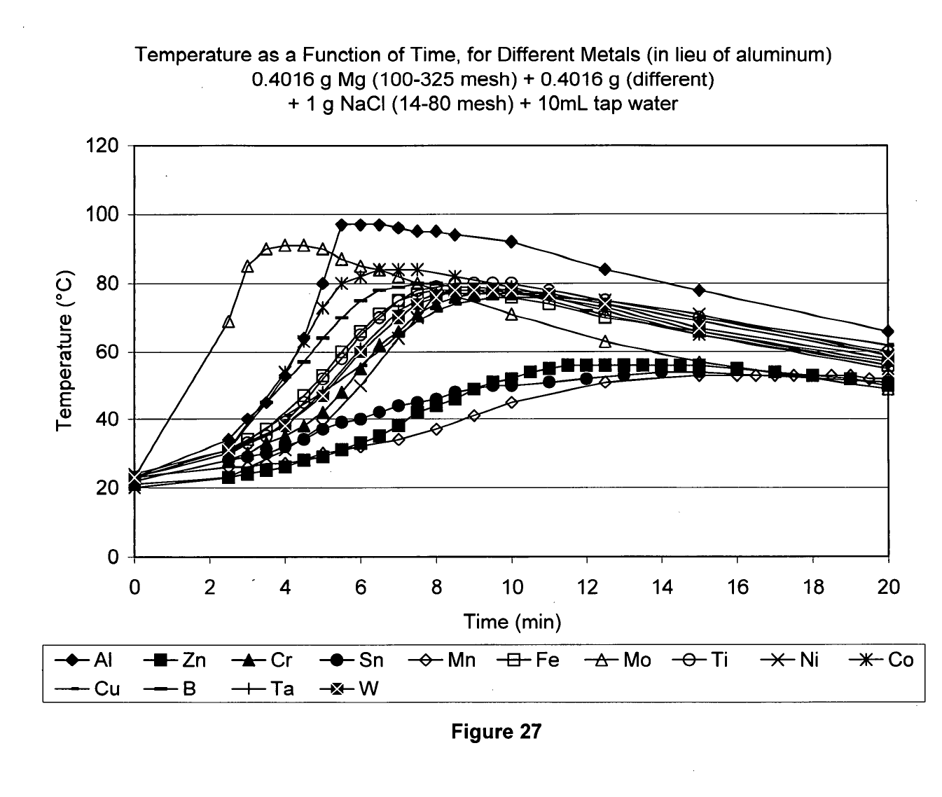

FIG. 28 is a data plot of temperature as a function of time, for reusability of passivated supported catalyst (versus no catalyst), in support of Example 17.

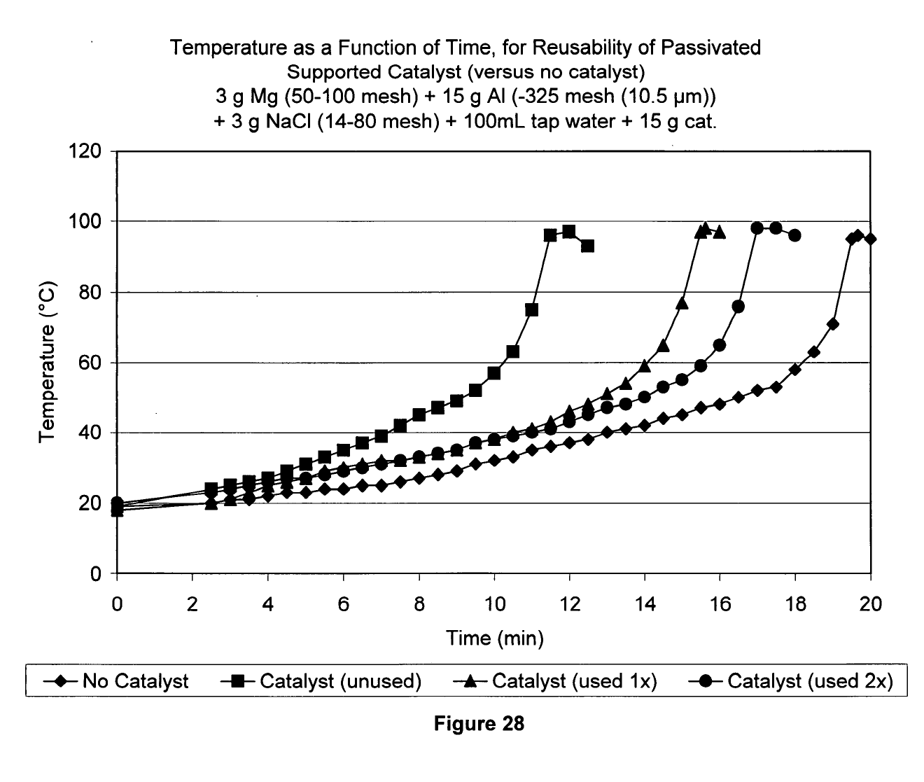

FIG. 29 is a data plot of volumetric yield (of hydrogen gas) as a function of time, for reusability of sodium chloride aqueous solution, in support of Example 18.

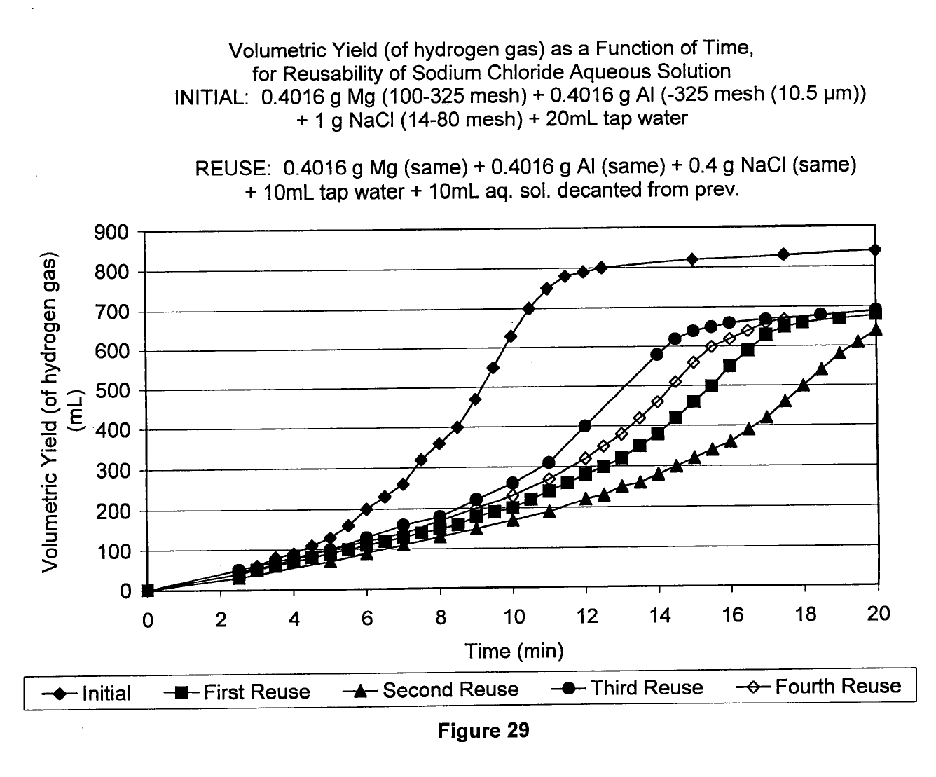

FIG. 30 is a data plot of hydrogen ion concentration (expressed as pH) as a function of time (for identical experimental runs), in support of Example 19.

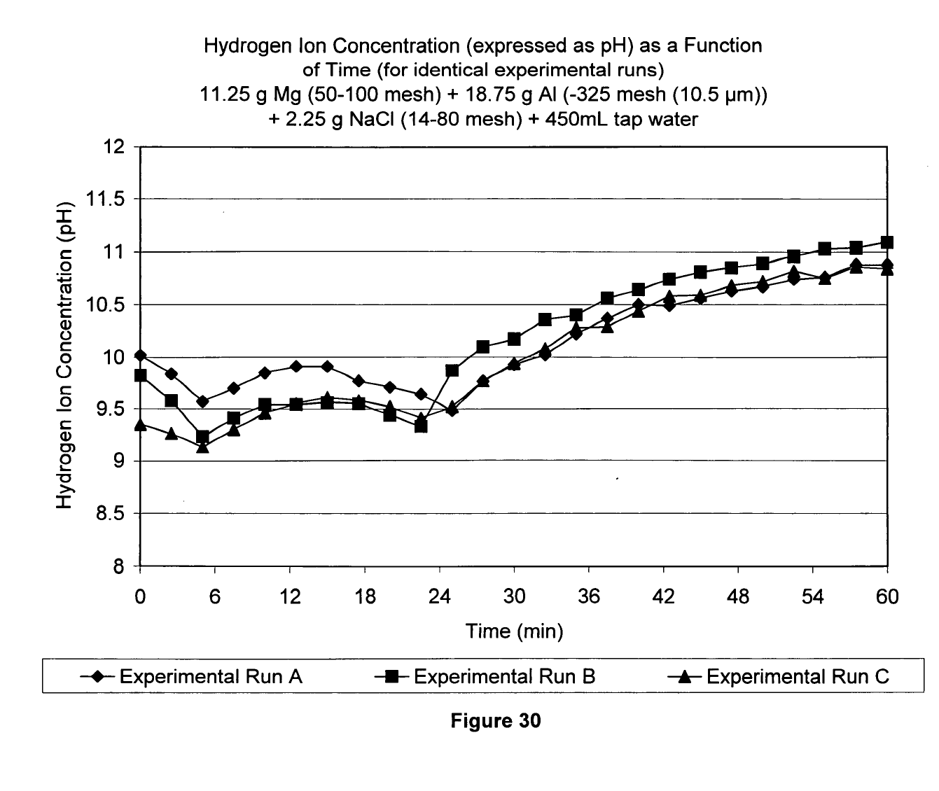

FIG. 31 is a data plot of normalized data as a function of time, for temperature, volumetric yield (of hydrogen gas), and hydrogen ion concentration (expressed as pH), in support of Example 19.

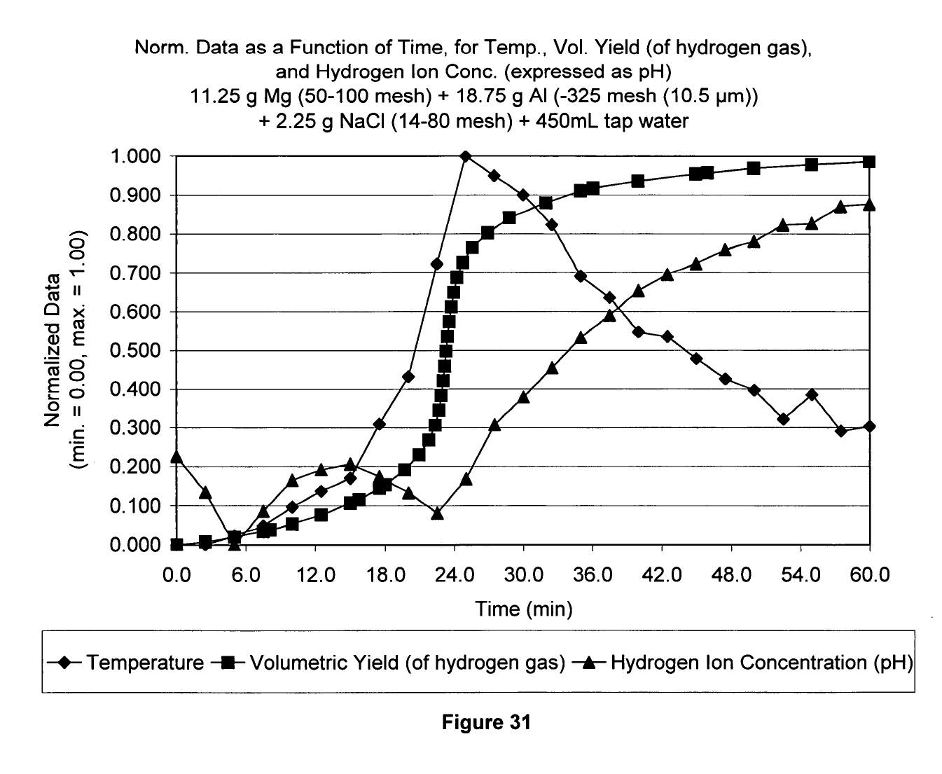

FIG. 32 is a data plot of volumetric yield (of hydrogen gas) as a function of time, for uncombined magnesium and for magnesium combined with molybdenum or different molybdenum compounds, in support of Example 20 and Example 21.

### DETAILED DESCRIPTION OF THE INVENTION

### Definitions

Unless defined otherwise, all technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

The term “mesh,” as used herein, shall refer to the particle size distribution of granular material in discrete solid (macroscopic) form, determined using test sieves of metal wire cloth in accordance with International Organization for Standardization (ISO) 3310-1:2000. When mesh is expressed as a numeric value (e.g., −325 mesh), a “+” prefix indicates that 90% of particles are retained by a test sieve of the designated numeric value and a “−” prefix indicates that 90% of particles pass through a test sieve of the designated numeric value. When mesh is expressed as a numeric range (e.g., 100-325 mesh), the indication is that 90% of particles are retained between test sieves of the two designated numeric values that constitute the designated numeric range.

The terms “d50” and “d90,” as used herein, shall refer to the particle size distribution of granular material in discrete solid (macroscopic) form, determined using laser light scattering or laser diffraction. When particle size distribution is expressed as d50, followed by a numeric value or numeric range (e.g., d50 3-5 microns), it indicates that 50% of particles have size greater than or equal to the designated numeric value or within the designated numeric range. When particle size distribution is expressed as d90, followed by a numeric value or numeric range (e.g., d90 10.5 microns), it indicates that 90% of particles have size greater than or equal to the designated numeric value or within the designated numeric range.

The term “finely divided,” as used herein, shall refer to granular or particulate material in discrete solid (macroscopic) form having certain particle size distribution such that 90% of particles pass through a test sieve of 14-mesh numeric value. Test sieve is of metal wire cloth in accordance with ISO 3310-1:2000.

The term “cold,” as used herein and in conjunction with the terms “tap water,” “deionized water,” and “seawater,” shall refer to water of the designated type classification that is under standard temperature and pressure conditions. Standard temperature and pressure conditions shall be understood as temperature of approximately 20-25° C. and pressure of approximately 1 atmosphere.

The term “chemically stable,” as used herein, shall refer to kinetic stability. Compositions that exhibit kinetic stability are persistent, and such compositions can be maintained almost indefinitely under standard temperature and pressure conditions. This definition differs from that of thermodynamic stability. Compositions that exhibit thermodynamic stability are at chemical equilibrium and, therefore, will not undergo a chemical reaction under standard temperature and pressure conditions. Compositions that exhibit thermodynamic instability do not necessarily also exhibit kinetic instability, and are considered to exhibit kinetic stability if the chemical reaction occurs so slowly under standard temperature and pressure conditions that it will not reach chemical equilibrium until after a very long period of time (i.e., magnitude of equilibrium constant is much less than 1).

### EXAMPLES OF THE PREFERRED EMBODIMENTS

Reference will now be made, in detail, to certain preferred embodiments of the present invention, examples of which are illustrated by the accompanying drawings and supported by empirical data collected from reduction of several of the preferred embodiments of the present invention to practice. The present invention may, however, be embodied in ways other than what is preferred or exemplified, and should not be construed as being limited to those embodiments of the present invention set forth herein.

### Example 1

Experiments were performed to study the provided composition for different magnesium particle sizes, holding all else constant. Four different magnesium particle sizes were studied, as follows: 100-325 mesh (Atlantic Equipment Engineers (AEE), MG-102), 50-100 mesh (AEE, MG-101), 30-50 mesh (AEE, MG-105), and 16-20 mesh (AEE, MG-109). Each experiment comprised 1 gram of finely divided magnesium of a different particle size, 1 gram of finely divided sodium chloride (American Chemical Society (ACS) reagent grade) of a 14-80 mesh particle size, and 5 grams of finely divided aluminum (Aluminum Company of America (ALCOA), Grade 120) of a 40-325 mesh particle size. Each of the four compositions was added to a separate reaction vessel (Pyrex® Brand Test Tube, No. 9800, 25 mm OD), to which 20 milliliters of cold tap water (20-25° C.) was also added. Temperature was measured and recorded as a function of time, since temperature is a measure of kinetic energy (and, therefore, chemical reaction kinetics).

Magnesium particle sizes 30-50 mesh and 16-20 mesh reacted to a negligible rate and extent, each resulting in a temperature rise of only 1° C. after the 20 minute duration of the experiment. The two smaller magnesium particle sizes reacted to a considerable rate and extent. Magnesium particle size 50-100 mesh resulted in a maximum temperature of 96° C., measured and recorded about 12 minutes into the experiment. Magnesium particle size 100-325 mesh resulted in a maximum temperature of 99° C., measured and recorded about 6 minutes into the experiment.

Experiments were repeated for magnesium particle sizes 30-50 mesh and 16-20 mesh, for finely divided aluminum of a smaller particle size. Each repeated experiment comprised 1 gram of finely divided magnesium of a different particle size, 1 gram of finely divided sodium chloride (ACS reagent grade) of a 14-80 mesh particle size, and 5 grams of finely divided aluminum (Valimet, H-3) of a −325 mesh (d90 10.5 micron) particle size. Each of the two compositions was added to a separate reaction vessel (Pyrex® Brand Test Tube, No. 9800, 25 mm OD), to which 20 milliliters of cold tap water (20-25° C.) was also added. Temperature was measured and recorded as a function of time, since temperature is a measure of kinetic energy (and, therefore, chemical reaction kinetics).

Once again, magnesium particle sizes 30-50 mesh and 16-20 mesh reacted to a negligible rate and extent. Magnesium particle size 16-20 mesh resulted in zero temperature rise after the 20 minute duration of the experiment. Magnesium particle size 30-50 mesh resulted in a temperature rise of only 7° C. during the 20 minute duration of the experiment. Based on the study results, the effective magnesium particle size limit exists in the 30-100 mesh (149-595 micron) range.

### Example 2

Experiments were performed to study the provided composition for different aluminum particle sizes, holding all else constant. Five different aluminum particle sizes were studied, as follows: −325 mesh (<1%+325 mesh, d90 10.5 micron; Valimet, H-3), −325 mesh (<1%+325 mesh, d90 22.0 micron; Valimet, H-10), 200-325 mesh (<6%+325 mesh, d90 52.0 micron; ALCOA, Grade 123), 100-325 mesh (18-22%+325 mesh, d90 85.0 micron; ALCOA, Grade 101), and 40-325 mesh (76-86%+325 mesh, d90 not applicable; ALCOA, Grade 120). Each experiment comprised 1 gram of finely divided magnesium (AEE, MG-102) of a 100-325 mesh particle size, 1 gram of finely divided sodium chloride (American Chemical Society (ACS) reagent grade) of a 14-80 mesh particle size, and 5 grams of finely divided aluminum of a different particle size. Each of the five compositions was added to a separate reaction vessel (Pyrex® Brand Test Tube, No. 9800, 25 mm OD), to which 20 milliliters of cold tap water (20-25° C.) was also added. Temperature was measured and recorded as a function of time, since temperature is a measure of kinetic energy (and, therefore, chemical reaction kinetics).

All aluminum particle sizes reacted to a considerable rate and extent. Aluminum particle sizes −325 mesh (d90 22.0 micron), 200-325 mesh, 100-325 mesh, and 40-325 mesh reacted the fastest, resulting in a maximum temperature of 98-101° C., measured and recorded about 6 minutes into the experiment. Aluminum particle size −325 mesh (d90 10.5 micron) reacted the second fastest, resulting in a maximum temperature of 112° C., measured and recorded about 8 minutes into the experiment. A maximum temperature of 112° C. was due to excessive evaporation of water (if an adequate volume of water is present in the reaction vessel, the maximum temperature should not exceed 100° C. by more than a few degrees).

Experiments were repeated for finely divided magnesium of a larger particle size. Each repeated experiment comprised 1 gram of finely divided magnesium (AEE, MG-101) of a 50-100 mesh particle size, 1 gram of finely divided sodium chloride (ACS reagent grade) of a 14-80 mesh particle size, and 5 grams of finely divided aluminum of a different particle size. Each of the five compositions was added to a separate reaction vessel (Pyrex® Brand Test Tube, No. 9800, 25 mm OD), to which 20 milliliters of cold tap water (20-25° C.) was also added. Temperature was measured and recorded as a function of time, since temperature is a measure of kinetic energy (and, therefore, chemical reaction kinetics).

Once again, all aluminum particle sizes reacted to a considerable rate and extent. Aluminum particle sizes −325 mesh (d90 10.5 micron) and −325 mesh (d90 22.0 micron) reacted the fastest, resulting in a maximum temperature of 100° C., measured and recorded about 11 minutes into the experiment. Aluminum particle sizes 200-325 mesh, mesh, and 40-325 mesh reacted the second fastest, resulting in a maximum temperature of 97-100° C., measured and recorded about 12 minutes into the experiment. Based on the study results, the effective aluminum particle size limit exists in the 325 mesh and greater (>44 microns) range.

### Example 3

Experiments were performed to study the provided composition for different sodium chloride forms, holding all else constant. Two different sodium chloride (ACS reagent grade) forms were studied: crystalline (i.e., solid) and aqueous solute. Each of the two experiments comprised 1 gram of finely divided magnesium (AEE, MG-101) of a 50-100 mesh particle size and 5 grams of finely divided aluminum (ALCOA, Grade 120) of a 40-325 mesh particle size. One of the two experiments further comprised 1 gram of finely divided sodium chloride (ACS reagent grade) of a 14-80 mesh particle size. Each of the two compositions was added to a separate reaction vessel (Pyrex® Brand Test Tube, No. 9800, 25 mm OD). Twenty (20) milliliters of cold tap water (20-25° C.) was added to the reaction vessel containing the mixture of magnesium, aluminum, and sodium chloride. Twenty (20) milliliters of cold tap water (20-25° C.), plus 1 gram of finely divided sodium chloride (ACS reagent grade), dissociated into sodium cations and chloride anions, was added to the reaction vessel containing the mixture of magnesium and aluminum. Temperature was measured and recorded as a function of time, since temperature is a measure of kinetic energy (and, therefore, chemical reaction kinetics).

Both sodium chloride forms catalyzed the reaction to a considerable rate and extent. Sodium chloride, added in crystalline (i.e., solid) form, accelerated the reaction more quickly, resulting in a maximum temperature of 98° C., measured and recorded about 11 minutes into the experiment. Sodium chloride, added in solute form, accelerated the reaction more slowly, resulting in a maximum temperature of 97° C., measured and recorded about 13 minutes into the experiment. Based on the study results, preference is given to sodium chloride added in crystalline (i.e. solid) form to the partial composition (prior to addition of the complete composition to tap water).

### Example 4

Experiments of Example 3 were repeated for water of a different type classification, to study the provided composition for different sodium chloride forms, and also to study the provided composition for the water type classifications, as follows: deionized water (American Society for Testing and Materials (ASTM) D 1193, type II) and seawater (ASTM D 1141, synthetic). Each of the four experiments comprised 1 gram of finely divided magnesium (AEE, MG-101) of a 50-100 mesh particle size and 5 grams of finely divided aluminum (ALCOA, Grade 120) of a 40-325 mesh particle size. One of the two experiments for deionized water further comprised 1 gram of finely divided sodium chloride (ACS reagent grade) of a 14-80 mesh particle size. One of the two experiments for seawater further comprised 0.4 gram of finely divided sodium chloride (ACS reagent grade) of a 14-80 mesh particle size. A mass of 0.4 gram was added in lieu of 1 gram because seawater, of the volume and type classification used for this experiment, already comprises 0.6 gram of sodium chloride, dissociated into sodium cations and chloride anions. Each of the four compositions was added to a separate reaction vessel (Pyrex® Brand Test Tube, No. 9800, 25 mm OD). Twenty (20) milliliters of cold deionized water (20-25° C.) was added to the reaction vessel containing the mixture of magnesium, aluminum, and sodium chloride (1 gram). Twenty (20) milliliters of cold seawater (20-25° C.) was added to the reaction vessel containing the mixture of magnesium, aluminum, and sodium chloride (0.4 gram). Twenty (20) milliliters of cold deionized water (20-25° C.), plus 1 gram of finely divided sodium chloride (ACS reagent grade), dissociated into sodium cations and chloride anions, was added to one of the two reaction vessels containing the mixture of magnesium and aluminum. Twenty (20) milliliters of cold seawater (20-25° C.), plus 0.4 gram of finely divided sodium chloride (ACS reagent grade), dissociated into sodium cations and chloride anions, was added to the other of the two reaction vessels containing the mixture of magnesium and aluminum. Temperature was measured and recorded as a function of time, since temperature is a measure of kinetic energy (and, therefore, chemical reaction kinetics).

Both water type classifications reacted to a considerable rate and extent, regardless of sodium chloride form. Deionized water reacted faster than seawater and about as fast as tap water. For experiments using tap and deionized water, sodium chloride, added in crystalline (i.e., solid) form, accelerated the reaction more quickly, resulting in a maximum temperature of 98-99° C., measured and recorded about 11 minutes into the experiment. Sodium chloride, added in solute form, accelerated the reaction more slowly, resulting in a maximum temperature of 97-98° C., measured and recorded about 12-13 minutes into the experiment. For the experiment using seawater, sodium chloride accelerated the reaction similarly for both forms, resulting in a maximum temperature of 68° C., measured and recorded about 23 minutes into the experiment. Based on the study results, preference is given to sodium chloride added in crystalline (i.e., solid) form to the partial composition (prior to addition of the complete composition to deionized water); however, no preference is given to sodium chloride added in crystalline (i.e., solid) form to the partial composition (prior to addition of the complete composition to seawater). Further, based on the study results, preference is given to tap and deionized water, in terms of the overall rate of reaction (i.e., time to reach maximum temperature).

### Example 5

Experiments were performed to study the provided composition for different magnesium to aluminum (w/w) ratios, holding all else constant. Twelve different magnesium to aluminum (w/w) ratios were studied, as follows: 1.000:0.000, 0.667:0.333, 0.500:0.500, 0.450:0.550, 0.400:0.600, 0.333:0.667, 0.300:0.700, 0.250:0.750, 0.150:0.850, 0.100:0.900, 0.050:0.950, and 0.010:0.990. Each of the twelve experiments comprised 1 gram of finely divided sodium chloride (ACS reagent grade) of a 14-80 mesh particle size and 0.8032 gram (combined mass) of finely divided magnesium (AEE, MG-102; 100-325 mesh) and finely divided aluminum (Valimet, H-3; d90 10.5 micron) of a different (w/w) ratio. A mass of 0.8032 gram represents a maximum theoretical yield, for the ideal magnesium to aluminum (w/w) ratio of 0.000:1.000, of exactly 1 liter of hydrogen gas under standard temperature and pressure conditions (1 liter is the maximum capacity of the volumetric measurement apparatus). Each of the twelve compositions was added to a separate reaction vessel (Pyrex® Brand Test Tube, No. 9800, 25 mm OD), to which 10 milliliters of cold tap water (20-25° C.) was also added. Temperature was measured and recorded as a function of time, since temperature is a measure of kinetic energy (and, therefore, chemical reaction kinetics). Volume (of hydrogen gas) was also measured and recorded as a function of time.

Magnesium to aluminum (w/w) ratios resulting in the fastest time to react (i.e., time to reach maximum temperature) were those between 1.000:0.000 and 0.450:0.550. Magnesium to aluminum (w/w) ratios resulting in the greatest volumetric yield (of hydrogen gas) after the 20 minute duration of the experiment were 0.250:0.750 and 0.300:0.700. Stoichiometric yield for each of the twelve compositions was calculated based on a maximum theoretical (volumetric) yield of 0.922 liter of hydrogen per 1 gram of magnesium and 1.245 liters of hydrogen per 1 gram of aluminum under standard temperature and pressure conditions. Greater than 90% of the stoichiometric yield, after the 20 minute duration of the experiment, was achieved for magnesium to aluminum (w/w) ratios between 0.500:0.500 and 0.250:0.750, and was also achieved for magnesium to aluminum (w/w) ratio of 1.000:0.000. Greater than 95% of the stoichiometric yield, after the 20 minute duration of the experiment, was achieved for magnesium to aluminum (w/w) ratios between 0.500:0.500 and 0.250:0.750. Greater than 99% of the stoichiometric yield, after the 20 minute duration of the experiment, was achieved for magnesium to aluminum (w/w) ratios between 0.400:0.600 and 0.300:0.700.

Experiments were repeated for magnesium of a different type, to study the provided composition for a different magnesium particle size, holding all else constant. Note that some of the constant parameters are different than above, specifically the reaction vessel form, magnesium and aluminum combined mass, sodium chloride mass, and water volume. These changes should not affect the relative chemical kinetics of the different magnesium to aluminum (w/w) ratios. Nine different magnesium to aluminum (w/w) ratios were studied, as follows: 1.000:0.000, 0.875:0.125, 0.750:0.250, 0.625:0.375, 0.500:0.500, 0.375:0.625, 0.250:0.750, 0.100:0.900, and 0.000:1.000. Each of the nine experiments comprised 5 grams of finely divided sodium chloride (ACS reagent grade) of a 14-80 mesh particle size and 10 grams (combined mass) of finely divided magnesium (AEE, MG-101; 50-100 mesh) and finely divided aluminum (Valimet, H-3; d90 10.5 micron) of a different (w/w) ratio. Each of the nine compositions was added to a separate reaction vessel (Pyrex® Brand Erlenmeyer Flask, No. 5000, 500 mL capacity), to which 250 milliliters of cold tap water (20-25° C.) was also added. Volume (of hydrogen gas) was measured and recorded as a function of time.

The magnesium to aluminum (w/w) ratio resulting in the greatest volumetric yield (of hydrogen gas) after the 1 hour duration of the experiment was 0.250:0.750. Stoichiometric yield for each of the twelve compositions was calculated based on a maximum theoretical (volumetric) yield of 0.922 liter of hydrogen per 1 gram of magnesium and 1.245 liters of hydrogen per 1 gram of aluminum under standard temperature and pressure conditions. Greater than 90% of the stoichiometric yield, after the 1 hour duration of the experiment, was achieved for magnesium to aluminum (w/w) ratios between 0.375:0.625 and 0.250:0.750, and was also achieved for magnesium to aluminum (w/w) ratio of 1.000:0.000. Greater than 95% of the stoichiometric yield, after the 1 hour duration of the experiment, was achieved for magnesium to aluminum (w/w) ratio of 0.250:0.750. Greater than 99% of the stoichiometric yield, after the 1 hour duration of the experiment, was not achieved for any of the nine magnesium to aluminum (w/w) ratios studied. Based on the study results, preference is given to magnesium to aluminum (w/w) ratios between 0.500:0.500 and 0.250:0.750, and also to magnesium to aluminum (w/w) ratio of 1.000:0.000.

### Example 6

Examples were performed to study the provided composition for different magnesium to sodium chloride (w/w) ratios, holding all else constant. Six different magnesium to sodium chloride (w/w) ratios were studied, as follows: 1.000:0.000, 1.000:0.001, 1.000:0.010, 1.000:0.100, 1.000:1.000, and 1.000:3.590. The ratio denominator 3.590 represents a saturated aqueous solution of sodium chloride under standard temperature and pressure conditions, for the volume of water used for the experiments. Each of the six experiments comprised 10 grams of finely divided magnesium (AEE, MG-101) of a 50-100 mesh particle size and a different mass (in accordance with a different magnesium to sodium chloride (w/w) ratio) of finely divided sodium chloride (ACS reagent grade) of a 14-80 mesh particle size. Each of the six compositions was added to a separate reaction vessel (Pyrex® Brand Erlenmeyer Flask, No. 5000, 500 mL capacity), to which 100 milliliters of cold tap water (20-25° C.) was also added. Volume (of hydrogen gas) was measured and recorded as a function of time.

Evaluating the experimental data based on volumetric yield (of hydrogen gas), magnesium to sodium chloride (w/w) ratios between 1.000:0.000 and 1.000:0.010 resulted in a negligible volumetric yield (of hydrogen gas) after the 1 hour duration of the experiment. Magnesium to sodium chloride (w/w) ratios between 1.000:0.100 and 1.000:3.590 resulted in a considerable volumetric yield (of hydrogen gas) after the 1 hour duration of the experiment. The magnesium to sodium chloride (w/w) ratio resulting in the greatest volumetric yield (of hydrogen gas) after the 1 hour duration of the experiment was 1.000:1.000. Magnesium to sodium chloride (w/w) ratio of 1.000:3.590 resulted in 5% less volumetric yield (of hydrogen gas) than magnesium to sodium chloride (w/w) ratio of 1.000:1.000. Magnesium to sodium chloride (w/w) ratio of 1.000:0.100 resulted in 28% less volumetric yield (of hydrogen gas) than magnesium to sodium chloride (w/w) ratio of 1.000:1.000.

Evaluating the experimental data based on volumetric rate of generation (of hydrogen gas), magnesium to sodium chloride (w/w) ratios between 1.000:0.000 and 1.000:0.010 resulted in a negligible volumetric rate of generation (of hydrogen gas) during the 1 hour experiment. Magnesium to sodium chloride (w/w) ratios between 1.000:0.100 and 1.000:3.590 resulted in a considerable volumetric rate of generation (of hydrogen gas) during the 1 hour experiment. The magnesium to sodium chloride (w/w) ratio resulting in the greatest volumetric rate of generation (of hydrogen gas) was 1.000:3.590. Magnesium to sodium chloride (w/w) ratio of 1.000:1.000 resulted in 27% less volumetric rate of generation (of hydrogen gas) than magnesium to sodium chloride (w/w) ratio of 1.000:3.590. Magnesium to sodium chloride (w/w) ratio of 1.000:0.100 resulted in 58% less volumetric rate of generation (of hydrogen gas) than magnesium to sodium chloride (w/w) ratio of 1.000:3.590. Based on the study results, preference is given, in general, to magnesium to sodium chloride (w/w) ratios greater than or equal to 1.000:0.100. For optimized volumetric yield (of hydrogen gas), preference is given to magnesium to sodium chloride (w/w) ratios of about 1.000:1.000. For optimized volumetric rate of generation (of hydrogen gas), preference is given to magnesium to sodium chloride (w/w) ratios of about 1.000:3.590.

### Example 7

Experiments were performed to study the provided composition for different magnesium to sodium chloride aqueous solution (w/w) ratios, holding all else constant. Nine different magnesium to sodium chloride aqueous solution (w/w) ratios were studied, as follows: 1.000:13.400, 1.000:26.800, 1.000:40.200, 1.000:53.600, 1.000:67.000, 1.000:80.400, 1.000:93.800, 1.000:107.200, and 1.000:120.600. Ratio denominators were calculated based on a resultant aqueous solution (molal) concentration of 5 grams of sodium chloride per 1 liter of water upon mixing. Each of the nine experiments comprised 3.75 grams of finely divided magnesium (AEE, MG-101; 50-100 mesh), 6.25 grams of finely divided aluminum (Valimet, H-3; d90 10.5 micron), and a different mass (in accordance with a different magnesium to sodium chloride aqueous solution (w/w) ratio) of finely divided sodium chloride (ACS reagent grade) of a 14-80 mesh particle size. Each of the nine compositions was added to a separate reaction vessel (Pyrex®Brand Erlenmeyer Flask, No. 5000, 500 mL capacity), to which a different volume (in accordance with a different magnesium to sodium chloride aqueous solution (w/w) ratio) of cold tap water (20-25° C.) was also added. Volume (of hydrogen gas) was measured and recorded as a function of time.

Evaluating the experimental data based on volumetric yield (of hydrogen gas), magnesium to sodium chloride aqueous solution (w/w) ratios between 1.000:40.200 and 1.000:107.200 resulted in the greatest volumetric yield (of hydrogen gas) after the 1 hour duration of the experiment. Magnesium to sodium chloride aqueous solution (w/w) ratio 1.000:26.800 resulted in 11-17% less volumetric yield (of hydrogen gas) than magnesium to sodium chloride (w/w) ratios between 1.000:40.200 and 1.000:107.200. Magnesium to sodium chloride aqueous solution (w/w) ratio 1.000:120.600 resulted in 19-24% less volumetric yield (of hydrogen gas) than magnesium to sodium chloride (w/w) ratios between 1.000:40.200 and 1.000:107.200. Magnesium to sodium chloride aqueous solution (w/w) ratio 1.000:13.400 resulted in 28-33% less volumetric yield (of hydrogen gas) than magnesium to sodium chloride (w/w) ratios between 1.000:40.200 and 1.000:107.200.

Evaluating the experimental data based on volumetric rate of generation (of hydrogen gas) and time to reach maximum volumetric rate of generation (of hydrogen gas), magnesium to sodium chloride aqueous solution (w/w) ratio of 1.000:13.400 resulted in the greatest volumetric rate of generation (of hydrogen gas), measured and recorded the soonest of all magnesium to sodium chloride aqueous solution (w/w) ratios studied. Magnesium to sodium chloride aqueous solution (w/w) ratios 1.000:26.800 and 1.000:40.200 resulted in 21-25% less volumetric rate of generation (of hydrogen gas) than magnesium to sodium chloride (w/w) ratio of 1.000:13.400, measured and recorded 10-12 minutes later. Based on the study results, for optimized volumetric yield (of hydrogen gas), preference is given to magnesium to sodium chloride (w/w) ratios between 1.000:40.200 and 1.000:107.200. For optimized volumetric rate of generation (of hydrogen gas) and time to reach maximum volumetric rate of generation (of hydrogen gas), preference is given to magnesium to sodium chloride (w/w) ratio of 1.000:13.400. For optimized rate and extent of reaction, preference is given to magnesium to sodium chloride (w/w) ratio of 1.000:40.200.

### Example 8

Experiments were performed to study the provided process for agitation of the reaction vessel contents, holding all else constant. Two process scenarios were studied, as follows: no agitation of the reaction vessel contents and continuous agitation of the reaction vessel contents. Each of the two experiments comprised 3.75 grams of finely divided magnesium (AEE, MG-101; 50-100 mesh), 6.25 grams of finely divided aluminum (Valimet, H-3; d90 10.5 micron), and 0.75 gram of finely divided sodium chloride (ACS reagent grade) of a 14-80 mesh particle size. Each of the two compositions was added to a separate reaction vessel (Pyrex® Brand Erlenmeyer Flask, No. 5000, 500 mL capacity), to which 150 milliliters of cold tap water (20-25° C.) was also added. One of the two flasks was partially immersed in an ultrasonic water bath (Cole-Parmer, FF-08895-02), operated at a frequency of 40 kilohertz. Volume (of hydrogen gas) was measured and recorded as a function of time.

Continuous agitation of the reaction vessel contents resulted in a greater volumetric yield (of hydrogen gas), but resulted in a volumetric rate of generation (of hydrogen gas) much less than no agitation of the reaction vessel contents, and measured and recorded much later into the experiment. Based on the study results, for an optimized volumetric rate of generation (of hydrogen gas), preference is given to no agitation of the reaction vessel contents. However, for an optimized volumetric yield (of hydrogen gas), and for a volumetric rate of generation (of hydrogen gas) that exhibits linear stability over time, preference is given to continuous agitation of the reaction vessel contents.

### Example 9

Experiments were performed to study the provided process for insulation of the reaction vessel, holding all else constant. Two process scenarios were studied, as follows: no insulation of the reaction vessel and insulation of the reaction vessel. Each of the two experiments comprised 1 gram of finely divided magnesium (AEE, MG-101) of a 50-100 mesh particle size and 1 gram of finely divided sodium chloride (American Chemical Society (ACS) reagent grade) of a 14-80 mesh particle size. Each of the two compositions was added to a separate reaction vessel (Pyrex® Brand Test Tube, No. 9800, 25 mm OD), to which 10 milliliters of cold tap water (20-25° C.) was also added. One of the two reaction vessels was insulated with approximately 1 inch thick of flexible silicone foam insulation (McMaster Carr, 9158T27). Temperature was measured and recorded as a function of time, since temperature is a measure of kinetic energy (and, therefore, chemical reaction kinetics). Volume (of hydrogen gas) was also measured and recorded as a function of time.

Insulation of the reaction vessel resulted in a greater maximum temperature than no insulation of the reaction vessel. This greater maximum temperature was measured and recorded sooner into the experiment. Insulation of the reaction vessel also resulted in a greater volumetric yield and rate of generation (of hydrogen gas) than no insulation of the reaction vessel. Based on the study results, preference is given to insulation of the reaction vessel.

### Example 10

Experiments were performed to study the provided process for inclusion of a catalyst component (unsupported) in the provided composition. Three different catalyst components (unsupported) were studied: finely divided carbonyl iron (International Specialty Products (ISP), Grade S-1640; d50 3-5 microns, d90 9.0 microns), finely divided ferric oxide (AEE, FE-601; 1-5 microns), or finely divided ferrous-ferric oxide (AEE, FE-602; 1-5 microns). Each of the three experiments comprised 1 gram of finely divided magnesium (AEE, MG-101) of a 50-100 mesh particle size, 1 gram of finely divided sodium chloride (ACS reagent grade) of a 14-80 mesh particle size, and 5 grams of finely divided aluminum (76-86%+325 mesh, d90 not applicable; ALCOA, Grade 120) of a 40-325 mesh particle size. Each of the three compositions was added to a separate reaction vessel (Pyrex® Brand Test Tube, No. 9800, 25 mm OD), to which 20 milliliters of cold tap water (20-25° C.) and 5 grams of a different catalyst component (unsupported) was also added. Temperature was measured and recorded as a function of time, since temperature is a measure of kinetic energy (and, therefore, chemical reaction kinetics).

Recorded data for the catalyzed compositions was compared to recorded data for an uncatalyzed composition. Inclusion of a finely divided carbonyl iron catalyst component (unsupported) resulted in only a slight improvement over the uncatalyzed composition, having reached the maximum temperature 1 minute (11%) sooner. Inclusion of a finely divided ferric oxide or ferrous-ferric oxide catalyst component (unsupported) resulted in a considerable improvement over the uncatalyzed composition, having reached the maximum temperature 5 minutes (38%) sooner. Inclusion of a finely divided ferric oxide or ferrous-ferric oxide catalyst component (unsupported) resulted in about the same improvement over the uncatalyzed composition. Based on the study results, preference is given to inclusion of a finely divided ferric oxide or ferrous-ferric oxide catalyst component.

### Example 11

Experiments of Example 10 were repeated to study the provided process for inclusion of a catalyst component (supported) in the provided composition. One supported catalyst component was studied, comprising finely divided carbonyl iron (ISP, Grade S-1640; d50 3-5 microns, d90 9.0 microns) supported on a low-carbon steel (American Iron and Steel Institute (AISI), C1008/1010; 5 mm×5 mm×80 μm) substrate. The supported catalyst was studied in two different forms, as follows: activated (i.e., carbonyl iron) and passivated (i.e., ferric oxide and/or ferrous-ferric oxide). Each of the two experiments comprised 1 gram of finely divided magnesium (AEE, MG-101) of a 50-100 mesh particle size, 1 gram of finely divided sodium chloride (ACS reagent grade) of a 14-80 mesh particle size, and 5 grams of finely divided aluminum (76-86%+325 mesh, d90 not applicable; ALCOA, Grade 120) of a 40-325 mesh particle size. Each of the six compositions was added to a separate reaction vessel (Pyrex® Brand Test Tube, No. 9800, 25 mm OD), to which 20 milliliters of cold tap water (20-25° C.) and 5 grams of a different catalyst component (supported) was also added. Temperature was measured and recorded as a function of time, since temperature is a measure of kinetic energy (and, therefore, chemical reaction kinetics).

Recorded data for the catalyzed compositions (supported) was compared to recorded data for the catalyzed compositions (unsupported) and to recorded data for an uncatalyzed composition. Inclusion of a supported carbonyl iron catalyst (i.e., in activated form) resulted in a considerable improvement over the unsupported finely divided carbonyl iron catalyst, having reached the maximum temperature 3 minutes (24%) sooner than the catalyzed (unsupported) composition and 4 minutes (32%) sooner than the uncatalyzed composition. Inclusion of a supported ferric oxide and/or ferrous-ferric oxide catalyst (i.e., in passivated form) resulted in a considerable improvement over the unsupported finely divided ferric oxide and unsupported ferrous-ferric oxide catalysts, having reached the maximum temperature 2 minutes (28%) sooner than the catalyzed (unsupported) composition and 7 minutes (55%) sooner than the uncatalyzed composition. Based on the study results, preference is given to a catalyst that is supported on a low carbon steel substrate.

### Example 12

Experiments were performed to study the provided process for inclusion of different masses of a passivated (i.e., ferric oxide and/or ferrous-ferric oxide) catalyst supported on a low-carbon steel (AISI, C1008/1010; 5 mm×5 mm×80 μm) substrate. Five different masses of the passivated supported catalyst were studied, as follows: 1 gram, 2 grams, 3 grams, 4 grams, and 5 grams. Each of the five experiments comprised 1 gram of finely divided magnesium (AEE, MG-101) of a 50-100 mesh particle size, 1 gram of finely divided sodium chloride (ACS reagent grade) of a 14-80 mesh particle size, and 5 grams of finely divided aluminum (76-86%+325 mesh, d90 not applicable; ALCOA, Grade 120) of a 40-325 mesh particle size. Each of the five compositions was added to a separate reaction vessel (Pyrex® Brand Test Tube, No. 9800, 25 mm OD), to which 20 milliliters of cold tap water (20-25° C.) and a different mass of the passivated supported catalyst was also added. Temperature was measured and recorded as a function of time, since temperature is a measure of kinetic energy (and, therefore, chemical reaction kinetics).

Recorded data for the catalyzed compositions of different passivated supported catalyst mass was compared to recorded data for an uncatalyzed composition. Inclusion of 1 gram of the passivated supported catalyst resulted in a maximum temperature of 96° C., measured and recorded 1 minute (7%) sooner that the uncatalyzed composition. Inclusion of 2 grams of the passivated supported catalyst resulted in a maximum temperature of 96° C., measured and recorded 1 minute (12%) sooner than the composition including 1 gram of the passivated supported catalyst and 3 minutes (21%) sooner than the uncatalyzed composition. Inclusion of 3 grams of the passivated supported catalyst resulted in a maximum temperature of 94° C., measured and recorded 2 minutes (11%) sooner that the composition including 2 grams of the passivated supported catalyst and 4 minutes (30%) sooner than the uncatalyzed composition. Inclusion of 4 grams of the passivated supported catalyst resulted in a maximum temperature of 94° C., measured and recorded 2 minutes (21%) sooner than the composition including 3 grams of the passivated supported catalyst and 5 minutes (45%) sooner than the uncatalyzed composition. Inclusion of 5 grams of the passivated supported catalyst resulted in a maximum temperature of 94° C., measured and recorded 1 minute (19%) sooner that the composition including 4 grams of the passivated supported catalyst and 7 minutes (55%) sooner than the uncatalyzed composition. Based on the study results, preference is given to the higher masses of the passivated supported catalyst. Furthermore, because the added mass of the passivated supported catalyst has a linear relationship to the time before the maximum temperature is reached, and because added masses of the passivated supported catalyst can be removed from the composition by physical (in lieu of chemical) means, the process can be controlled.

### Example 13

Experiments were performed to study the provided composition for different salt chemistries, holding all else constant. Nine different salt chemistries were studied, as follows: potassium bromide (ACS reagent grade), potassium chloride (ACS reagent grade), potassium iodide (>99% purity), potassium permanganate (>97% purity), ammonium chloride (ACS reagent grade), ammonium fluoride (pure assay, 100%), sodium bromide (ACS reagent grade), sodium chloride (ACS reagent grade), and sodium fluoride (ACS reagent grade). Particle size identification is not important for the different salt chemistries used for experiments, since the different salt chemistries will be dissolved into aqueous solution before starting the experiments. Each of the nine experiments comprised 3.75 grams of finely divided magnesium (AEE, MG-101; 50-100 mesh) and 6.25 grams of finely divided aluminum (Valimet, H-3; d90 10.5 micron). Each of the nine compositions was added to a separate reaction vessel (Pyrex® Brand Erlenmeyer Flask, No. 5000, 500 mL capacity), to which 250 milliliters of cold tap water (20-25° C.), plus 5 grams of a different salt chemistry, dissociated into its respective cations and anions, was also added. Volume (of hydrogen gas) was measured and recorded as a function of time.

Sodium chloride, potassium chloride, and ammonium chloride catalyzed the reaction to a considerable extent. All other salt chemistries catalyzed the reaction to a negligible extent. Sodium chloride and potassium chloride resulted in the greatest volumetric yield (of hydrogen gas) after the 1 hour duration of the experiment, and also resulted in the greatest volumetric rate of generation (of hydrogen gas), measured and recorded at approximately the same time into the experiment. Sodium chloride resulted in 20% greater volumetric rate of generation (of hydrogen gas) than potassium chloride, and only 1% less volumetric yield (of hydrogen gas). Ammonium chloride resulted in 31-32% less volumetric yield (of hydrogen gas) than sodium chloride and potassium chloride after the 1 hour duration of the experiment, and resulted in 88-90% less volumetric rate of generation (of hydrogen gas). Based on the study results, preference is given to chloride salt chemistries, specifically to sodium chloride and potassium chloride, and more specifically to sodium chloride.

### Example 14

Experiments were performed to study the provided process for different reaction vessel scaling, holding all else constant. Reaction vessel form used for experiments was Pyrex® Brand Beaker, No. 1000. Four different reaction vessel scaling were studied, as follows: 100 milliliter (80 milliliter calibrated) capacity, 250 milliliter (200 milliliter calibrated) capacity, 600 milliliter (500 milliliter calibrated) capacity, and 1000 milliliter (1000 milliliter calibrated) capacity. The first of the four experiments comprised 2 grams of finely divided magnesium (AEE, MG-102) of a 100-325 mesh particle size, 2 grams of finely divided sodium chloride (ACS reagent grade) of a 14-80 mesh particle size, and 40 milliliters of cold tap water (20-25° C.), which were combined in the reaction vessel of 100 milliliter (80 milliliter calibrated) capacity. The second of the four experiments comprised 5 grams of finely divided magnesium (AEE, MG-102) of a 100-325 mesh particle size, 5 grams of finely divided sodium chloride (ACS reagent grade) of a 14-80 mesh particle size, and 100 milliliters of cold tap water (20-25° C.), which were combined in the reaction vessel of 250 milliliter (200 milliliter calibrated) capacity. The third of the four experiments comprised 12.5 grams of finely divided magnesium (AEE, MG-102) of a 100-325 mesh particle size, 12.5 grams of finely divided sodium chloride (ACS reagent grade) of a 14-80 mesh particle size, and 250 milliliters of cold tap water (20-25° C.), which were combined in the reaction vessel of 600 milliliter (500 milliliter calibrated) capacity. The last of the four experiments comprised 25 grams of finely divided magnesium (AEE, MG-102) of a 100-325 mesh particle size, 25 grams of finely divided sodium chloride (ACS reagent grade) of a 14-80 mesh particle size, and 500 milliliters of cold tap water (20-25° C.), which were combined in the reaction vessel of 1000 milliliter (1000 milliliter calibrated) capacity. Temperature was measured and recorded as a function of time, since temperature is a measure of kinetic energy (and, therefore, chemical reaction kinetics).

The reactive components of the provided compositions reacted with the water to a considerable rate and extent for all reaction vessel scaling studied. Maximum temperature of 70-81° C. was measured and recorded 13-15 minutes into each experiment. The larger reaction vessel scaling was able to maintain higher temperatures for longer periods of time. Based on the study results, no preference is given to any specific reaction vessel scaling. However, increased retention of heat by larger reaction scaling could, in theory, contribute favorably to the chemical kinetics of the reaction.

### Example 15

Experiments were performed to study the provided composition for different finely divided metals in lieu of magnesium or aluminum, holding all else constant. Thirteen different finely divided metals were studied, as follows: manganese (North American Höganäs, E-130-ASC-310; d50 11-14 microns, d90 35 microns), zinc (AEE, ZN-101; 1-5 microns), chromium (AEE, CR-102; 1-5 microns), iron (ISP, Grade S-1640; d50 3-5 microns, d90 9.0 microns), tin (AEE, SN-101; 1-5 microns), titanium (AEE, TI-101; 1-5 microns), molybdenum (AEE, MO-102; 1-5 microns), nickel (Novamet, Type 525; 96%-325 mesh), cobalt (Accumet; 0.5-1.5 microns), copper (CERAC, C-1133; 3-10 microns), boron (SB Boron, elemental amorphous; d50 0.5-2.5 microns), tantalum (AEE; d50 1-8 microns, d90 20 microns), and tungsten (Acrōs, 317841000; 12 microns). Each finely divided metal was used in two separate experiments—one for direct mass substitution of magnesium in the provided composition, and another for direct mass substitution of aluminum in the provided composition. Each of the twenty-six experiments comprised 0.4016 grams of finely divided magnesium (AEE, MG-102; 100-325 mesh) or direct mass substitute for a different finely divided metal, 0.4016 grams of finely divided aluminum (Valimet, H-3; d90 10.5 micron) or direct mass substitute for a different finely divided metal, and 1 gram of finely divided sodium chloride (ACS reagent grade) of a 14-80 mesh particle size. Each of the twenty-six compositions was added to a separate reaction vessel (Pyrex® Brand Test Tube, No. 9800, 25 mm OD), to which 10 milliliters of cold tap water (20-25° C.) was also added. Temperature was measured and recorded as a function of time, since temperature is a measure of kinetic energy (and, therefore, chemical reaction kinetics). Volume (of hydrogen gas generated) was also measured and recorded as a function of time.

Recorded data for the compositions having a direct mass substitute for a different finely divided metal were compared to recorded data for the composition having 50 wt. % finely divided magnesium and 50 wt. % finely divided aluminum. As a direct mass substitute for magnesium, all of the finely divided metals reacted to a negligible rate and extent. After the 20 minute duration of the experiment, all resulted in zero temperature rise and zero volumetric yield (of hydrogen gas). As a direct mass substitute for aluminum, none of the finely divided metals reacted to the extent realized by finely divided aluminum; and, except for molybdenum, none of the finely divided metals reacted to the rate realized by finely divided aluminum. After the 20 minute duration of the experiment, all of the finely divided metals (except for molybdenum) resulted in a volumetric yield (of hydrogen gas) less than or equal to the stoichiometric yield for the magnesium component mass alone. The magnesium-molybdenum combined mass (i.e., the magnesium powder, the molybdenum powder and the NaCl powder) resulted in a maximum temperature of 91° C., measured and recorded 2 minutes (27%) sooner than the magnesium-aluminum combined mass (i.e., the magnesium powder, the aluminum powder and the NaCl powder). Further, the magnesium-molybdenum combined mass reached a temperature of 69° C. and a volumetric yield (of hydrogen gas) of 240 milliliters at 3 minutes into the experiment, whereas the magnesium-aluminum combined mass reached a temperature of only 40° C. and a volumetric yield (of hydrogen gas) of only 80 milliliters at 3 minutes into the experiment. The magnesium-aluminum combined mass did not reach a temperature of 69° C. and a volumetric yield (of hydrogen gas) of 240 milliliters until 5 minutes into the experiment. Yet further, the magnesium-molybdenum combined mass reached its final volumetric yield (of hydrogen gas) only 6 minutes into the experiment, whereas the magnesium-aluminum combined mass reached its final volumetric yield (of hydrogen gas) 20 minutes into the experiment. However, the final volumetric yield (of hydrogen gas) for the magnesium-molybdenum combined mass was 410 milliliters (49%) less than the final volumetric yield (of hydrogen gas) for the magnesium-aluminum combined mass. Based on the study results, for optimized volumetric yield (of hydrogen gas), preference is given to the magnesium-aluminum combined mass. For optimized volumetric rate of generation (of hydrogen gas), preference is given to the magnesium-molybdenum combined mass.

### Example 16

Experiments were performed to study the chemical stability of the provided composition in water under standard temperature and pressure conditions, for individual components and mixtures thereof. Two individual components were studied, as follows: finely divided magnesium (AEE, MG-102; 100-325 mesh), and finely divided aluminum (Valimet, H-3; d90 10.5 microns). Because sodium chloride does not take part in the reaction (i.e., does not form reaction products), it was not studied. Two partial compositions were studied, as follows: mixture of finely divided magnesium (AEE, MG-102; 100-325 mesh) and finely divided aluminum (Valimet, H-3; d90 10.5 microns), and mixture of finely divided aluminum (Valimet, H-3; d90 10.5 microns) and finely divided sodium chloride (ACS reagent grade) of a 14-80 mesh particle size. Because finely divided magnesium is known to react with water in the presence of sodium chloride, the partial composition of finely divided magnesium and sodium chloride was not studied. The first of the three experiments comprised 2 grams of finely divided magnesium (AEE, MG-102; 100-325 mesh). The second of the three experiments comprised 1 gram of finely divided magnesium (AEE, MG-102; 100-325 mesh) and 1 gram of finely divided aluminum (Valimet, H-3; d90 10.5 microns). The last of the three experiments comprised 1 gram of finely divided aluminum (Valimet, H-3; d90 10.5 microns) and 1 gram of finely divided sodium chloride (ACS reagent grade) of a 14-80 mesh particle size. Each of the three partial compositions was added to a separate reaction vessel (Pyrex® Brand Test Tube, No. 9800, 25 mm OD), to which 2 milliliters of cold tap water (20-25° C.) was also added. A volume of water of only 2 milliliters (lower than what has been used for other examples) was used to achieve relatively high concentration of ions in aqueous solution, such that relative activity level will be increased. Temperature was measured and recorded as a function of time, since temperature is a measure of kinetic energy (and, therefore, chemical reaction kinetics). Volume (of hydrogen gas) was also measured and recorded as a function of time.

Both of the individual components and both of the partial compositions reacted to a negligible rate and extent. After the 20 minute duration of the experiment, all resulted in zero temperature rise and zero volumetric yield (of hydrogen gas). Based on the study results, the provided composition, in terms of the individual components and mixtures thereof, is chemically stable (except for the partial composition of finely divided magnesium and sodium chloride).

### Example 17

An experiment was performed to study the provided process for reusability of the passivated supported catalyst of Example 12, holding all else constant. The initial experiment, and each subsequent repeat thereof, comprised 3 grams of finely divided magnesium (AEE, MG-101; 50-100 mesh), 15 grams of finely divided aluminum (Valimet, H-3; d90 10.5 micron), and 3 grams of finely divided sodium chloride (ACS reagent grade) of a 14-80 mesh particle size. The composition of the initial experiment, and each subsequent repeat thereof, was added to a separate reaction vessel (Pyrex® Brand Beaker, No. 1000, 250 milliliter capacity), to which 100 milliliters of cold tap water (20-25° C.) was also added. Temperature was measured and recorded as a function of time, since temperature is a measure of kinetic energy (and, therefore, chemical reaction kinetics). Before each subsequent repeat of the initial experiment, the passivated supported catalyst was thoroughly rinsed to remove any particulate matter not tenaciously held at the surface.

Recorded data for the catalyzed composition was compared to recorded data for an uncatalyzed composition. The catalyzed composition, using catalyst that is new (unused), resulted in a maximum temperature of 97° C., measured and recorded 8 minutes (39%) sooner into the experiment than the uncatalyzed composition. The catalyzed composition, using catalyst that has been used once previously, resulted in a maximum temperature of 98° C., measured and recorded 4 minutes (21%) sooner into the experiment than the uncatalyzed composition. The catalyzed composition, using catalyst that has been used twice previously, resulted in a maximum temperature of 98° C., measured and recorded 3 minutes (14%) sooner into the experiment than the uncatalyzed composition. Based on the study results, the passivated supported catalyst of Example 12 is reusable; however, catalytic activity decreases with each subsequent repeat of use.

### Example 18

An experiment was performed to study the provided process for reusability of the sodium chloride aqueous solution, holding all else constant. The initial experiment comprised 0.4016 gram of finely divided magnesium (AEE, MG-102; 100-325 mesh), 0.4016 gram of finely divided aluminum (Valimet, H-3; d90 10.5 micron), and 1 gram of finely divided sodium chloride (ACS reagent grade) of a 14-80 mesh particle size. Each subsequent repeat of the experiment comprised 0.4016 gram of finely divided magnesium (AEE, MG-102; 100-325 mesh), 0.4016 gram of finely divided aluminum (Valimet, H-3; d90 10.5 micron), and 0.5 gram of finely divided sodium chloride (ACS reagent grade) of a 14-80 mesh particle size. The rationale for 0.5 gram of finely divided sodium chloride will become apparent later in the example. The composition of the initial experiment was added to a separate reaction vessel (Pyrex® Brand Test Tube, No. 9800, 25 mm OD), to which 20 milliliters of cold tap water (20-25° C.) was also added. The composition of each subsequent repeat of the initial experiment was added to a separate reaction vessel (Pyrex® Brand Test Tube, No. 9800, 25 mm OD), to which 10 milliliters of cold tap water (20-25° C.) and 10 milliliters of sodium chloride aqueous solution, decanted from the reaction vessel of the previous iteration of the experiment, was also added. Volume (of hydrogen gas) was measured and recorded as a function of time.

The initial experiment resulted in a volumetric yield (of hydrogen gas) of 840 milliliters (97% of stoichiometric yield) after the 20 minute duration of the experiment. The initial experiment was repeated a total of four times. Each subsequent repeat of the initial experiment resulted in a volumetric yield (of hydrogen gas) of between 640 milliliters and 690 milliliters (74-79% of stoichiometric yield). Based on the study results, the sodium chloride aqueous solution is reusable. However, preference is given to unused sodium chloride aqueous solution (or crystalline (i.e., solid) form, added to water).

### Example 19

An experiment was performed to study the provided process for hydrogen ion concentration, expressed in terms of pH (i.e., negative logarithm of the hydrogen ion concentration), holding all else constant. The experiment, which was repeated three times, comprised 11.25 grams of finely divided magnesium (AEE, MG-101; 50-100 mesh), 18.75 grams of finely divided aluminum (Valimet, H-3; d90 10.5 micron), and 2.25 grams of finely divided sodium chloride (ACS reagent grade) of a 14-80 mesh particle size. The composition was added to a separate reaction vessel (Pyrex® Brand Beaker, No. 1000, 600 milliliter capacity), to which 450 milliliters of cold tap water (20-25° C.) was also added. Hydrogen ion concentration, expressed in terms of pH, was measured and recorded as a function of time. Baseline pH was measured and recorded for water and the following chemically stable partial compositions (in water): 450 milliliters of cold tap water (20-25° C.), 450 milliliters of cold tap water (20-25° C.) plus 2.25 grams of finely divided sodium chloride (ACS reagent grade) of a 14-80 mesh particle size, 450 milliliters of cold tap water (20-25° C.) plus 11.25 grams of finely divided magnesium (AEE, MG-101; 50-100 mesh), 450 milliliters of cold tap water (20-25° C.) plus 18.75 grams of finely divided aluminum (Valimet, H-3; d90 10.5 micron), and 450 milliliters of cold tap water (20-25° C.) plus 18.75 grams of finely divided aluminum (Valimet, H-3; d90 10.5 micron) plus 2.25 grams of finely divided sodium chloride (ACS reagent grade) of a 14-80 mesh particle size.

Recorded data for pH was cross referenced with recorded data for temperature and volumetric yield (of hydrogen gas) for the provided composition and process. The baseline pH is approximately neutral (6.87-7.25) for water and all chemically stable partial compositions (in water) except for the partial composition of 450 milliliters of cold tap water (20-25° C.) plus 11.25 grams of finely divided magnesium (AEE, MG-101; 50-100 mesh), which had a baseline pH of 10.37—making it a weak base (strong bases typically have a pH greater than 12). The (complete) composition had an initial pH of 9.35-10.02, but rapidly decreased to the first local minimum pH of 9.13-9.57, measured and recorded 5 minutes into the experiment. Thereafter, pH rapidly increased to a local maximum 9.56-9.91 (approximately equal to the initial pH), measured and recorded 15 minutes into the experiment. Thereafter, pH again rapidly decreased to the second local minimum of 9.33-9.48 (approximately equal to the first local minimum pH), measured and recorded 23-25 minutes into the experiment. Between the local maximum (15 minutes into the experiment) and the second local minimum (23-25 minutes into the experiment), the rate of temperature rise and the volumetric rate of generation (of hydrogen gas) rapidly increased. Maximum temperature and maximum volumetric rate of generation (of hydrogen gas) are realized at approximately the same time that the second local minimum pH is realized. Thereafter, pH rapidly (then more gradually) increased to a final pH of 10.84-11.09 (weak base) after the 1 hour duration of the experiment. Based on the study results, the intermediate (i.e. stepwise reaction) and overall reaction products of the provided process are chemically stable, and are neither corrosive nor caustic.

### Example 20

Experiments were performed to further study the provided composition for finely divided molybdenum (and molybdenum oxides) in lieu of aluminum, holding all else constant. Interest in further study was the direct result of preference given to the magnesium-molybdenum combined mass of Example 15. One finely divided molybdenum and two different finely divided molybdenum oxides were studied, as follows: molybdenum (AEE, MO-102; 1-5 microns), molybdenum dioxide (Aldrich, 234761; unspecified particle size), and molybdenum trioxide (Aldrich, 203815; unspecified particle size). Each of three experiments comprised 0.5000 grams of finely divided magnesium (AEE, MG-102; 100-325 mesh), 10 milligrams of either finely divided molybdenum or a particular molybdenum oxide, and 1 gram of finely divided sodium chloride (ACS reagent grade) of a 14-80 mesh particle size. A fourth experiment, the control reference, comprised only 0.5000 grams of finely divided magnesium (AEE, MG-102; 100-325 mesh) and 1 gram of finely divided sodium chloride (ACS reagent grade) of a 14-80 mesh particle size. Each of the four compositions was added to a separate reaction vessel (Pyrex® Brand Test Tube, No. 9800, 25 mm OD), to which 10 milliliters of cold tap water (20-25° C.) was also added. Volume (of hydrogen gas) was measured and recorded as a function of time.

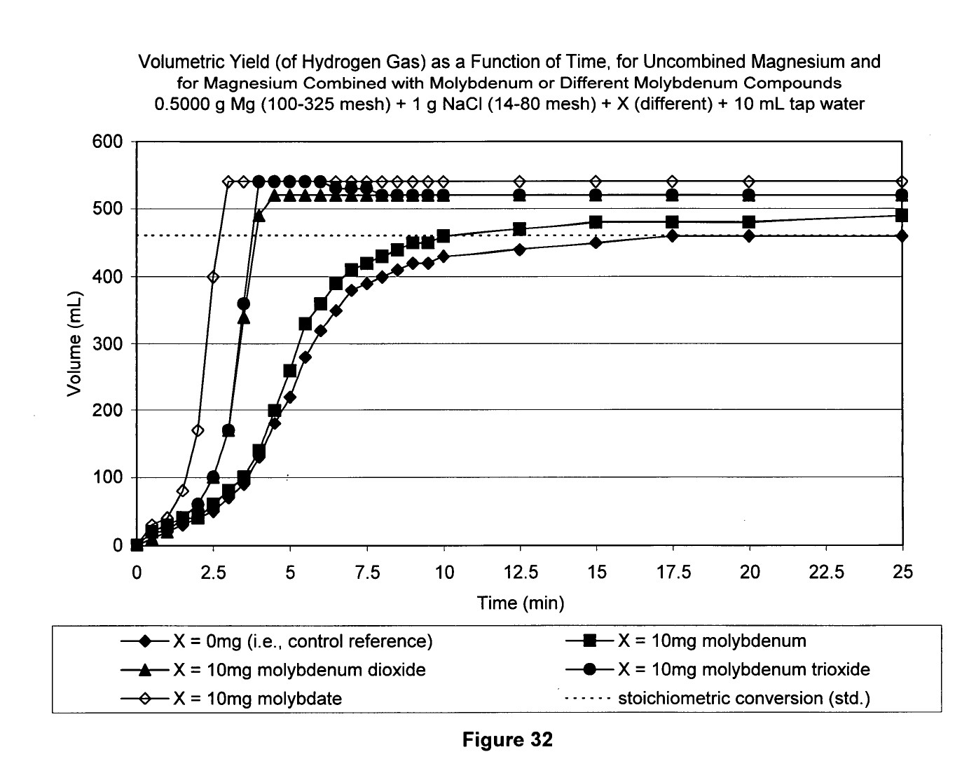

After the 25 minute duration of the experiments, the magnesium-molybdenum combined mass resulted in a slightly greater volumetric yield and rate of generation (of hydrogen gas) than the magnesium uncombined mass (i.e., the control reference). The magnesium-molybdenum dioxide combined mass (i.e., the magnesium powder, the molybdenum dioxide powder and the NaCl powder) and magnesium-molybdenum trioxide combined mass (i.e., the magnesium powder, the molybdenum trioxide powder and the NaCl powder) resulted in a far greater volumetric yield and rate of generation (of hydrogen gas) than the magnesium-molybdenum combined mass and magnesium uncombined mass. Volumetric yield (of hydrogen gas), consistent with complete stoichiometric conversion of 0.5000 grams of magnesium to magnesium hydroxide, is exactly 0.46 standard liters. Accordingly, each of the four compositions resulted in (at least) complete stoichiometric conversion (see FIG. 32). However, it is of greater importance to note the relative times at which stoichiometric conversion was completed. The magnesium uncombined mass resulted in complete stoichiometric conversion after 17.5 minutes. The magnesium-molybdenum combined mass resulted in complete stoichiometric conversion after about 10 minutes. The magnesium-molybdenum dioxide and magnesium-molybdenum trioxide combined masses both resulted in complete stoichiometric conversion after 3.75 minutes. Based on the study results, small amounts of finely divided molybdenum (less preferred) or a particular molybdenum oxide (more preferred), when combined with finely divided magnesium in the provided composition, accelerate the initiation and propagation of the chemical reaction and promote an increased volumetric yield and rate of generation (of hydrogen gas) when compared to the magnesium uncombined mass (i.e., the control reference).

### Example 21

An additional experiment was performed to yet further study the provided composition for finely divided molybdenum (and molybdenum oxides) in lieu of aluminum, holding all else constant. Interest in yet further study was the indirect result of preference given to the magnesium-molybdenum combined mass of Example 15, and was the direct result of preference given to the magnesium-molybdenum dioxide and magnesium-molybdenum trioxide combined masses of Example 20. A water-soluble intermediate molybdenum oxide (herein referred to as molybdate) was prepared by slowly admixing finely divided molybdenum (AEE, MO-102; 1-5 microns) with concentrated hydrogen peroxide (29.0-32.0% aqueous solution) in a jacketed vessel that is continuously chilled by cold tap water flow supply to slow thermal decomposition of hydrogen peroxide, otherwise accelerated by exothermic oxidation of the molybdenum. As the molybdenum was added in small incremental amounts to the hydrogen peroxide, the transitional clarity (initially clear) and color (initially colorless) was observed and recorded, as such: opaque gray>opaque gray w/green hue>translucent gray w/yellow hue>clear yellow>clear yellow w/orange hue>clear orange>clear red>translucent brown>translucent green>opaque blue w/green hue>opaque blue. Note that complete dissociation of molybdenum (residual and subsequent additions) into solution was noted at all transitional clarities and colors following clear yellow. The final clarity and color, opaque blue, was observed and recorded after adding 5 grams of molybdenum per 100 grams of hydrogen peroxide. After the completion of the addition of the 5 grams of molybdenum to the hydrogen peroxide aqueous solution, the molybdenum-hydrogen peroxide aqueous solution was heated, first on a +100° C. hot plate to thermally decompose the residual hydrogen peroxide and to evaporate most of the liquid water (residual and decomposition product), then in a +100° C. oven to evaporate the remaining moisture. The resulting solid crystals were then ground into a finely divided form. The experiment comprised 0.5000 grams of finely divided magnesium (AEE, MG-102; 100-325 mesh), 10 milligrams of the molybdate (as prepared), and 1 gram of finely divided sodium chloride (ACS reagent grade) of a 14-80 mesh particle size. The composition was added to a reaction vessel (Pyrex® Brand Test Tube, No. 9800, 25 mm OD), to which 10 milliliters of cold tap water (20-25° C.) was also added. Volume (of hydrogen gas) was measured and recorded as a function of time.

After the 25 minute duration of the experiment, the magnesium-molybdate combined mass (i.e., the magnesium powder, the molybdate powder and the NaCl powder) resulted in an even greater volumetric yield and rate of generation (of hydrogen gas) than the magnesium-molybdenum dioxide and magnesium-molybdenum trioxide combined masses of Example 20 (see FIG. 32). Furthermore, the magnesium-molybdate combined mass resulted in complete stoichiometric conversion after only 2.5 minutes, whereas the magnesium-molybdenum dioxide and magnesium-molybdenum trioxide combined masses both resulted in complete stoichiometric conversion after 3.75 minutes. Based on the study results, combination of magnesium with a small amount of the molybdate (as prepared) is preferred to combination of magnesium with small amounts of finely divided molybdenum or a particular molybdenum oxide.

### Additional Discussion of Preferred Embodiments

In view of the foregoing description of the invention and the examples, the embodiments of the invention discussed below can be said to be preferred. These are not the only preferred embodiments of the present invention and should not be interpreted in any way as limiting the scope of the invention to the embodiments discussed below.

Embodiment one is a composition for the production of hydrogen gas from water, wherein said composition comprises either:

(A) magnesium powder with a particle size of −50 mesh and a chloride salt; or
(B) magnesium powder with a particle size of −50 mesh, aluminum powder with a particle size of −40 mesh and a chloride salt. In this embodiment of the present invention, the magnesium powder can also have a particle size of −100 mesh. When aluminum powder is present, it may also have a particle size of −325 mesh. The chloride salt is preferably sodium chloride or potassium chloride.

Embodiment two is a hydrogen gas generation system, wherein said system comprises either:

(A) magnesium powder with a particle size of −50 mesh, a chloride salt and water; or
(B) magnesium powder with a particle size of −50 mesh, aluminum powder with a particle size of −40 mesh, a chloride salt and water. In this embodiment of the present invention, the magnesium powder can also have a particle size of −100 mesh. When aluminum powder is present, it may also have a particle size of −325 mesh. The chloride salt is preferably sodium chloride or potassium chloride. The water that is used can be fresh water (e.g., non-potable water, potable water, distilled water, double distilled water or deionized water) or salt water (e.g., any type of saltwater wherein the water contains at least some amount of one or more chloride salts; including, but not limited to, natural seawater and artificial seawater).

Embodiment three is a process for the displacement of hydrogen from water so as to obtain hydrogen gas, comprising the steps:

(a) adding a composition comprising either: (i) magnesium powder with a particle size of −50 mesh and a chloride salt; or (ii) magnesium powder with a particle size of −50 mesh, aluminum powder with a particle size of −40 mesh and a chloride salt; to water to form a hydrogen gas generation system; and
(b) collecting hydrogen gas from said hydrogen gas generation system. In this embodiment of the present invention, the magnesium powder can also have a particle size of −100 mesh. When aluminum powder is present, it may also have a particle size of −325 mesh. The chloride salt is preferably sodium chloride or potassium chloride. The water that is used can be fresh water (e.g., non-potable water, potable water, distilled water, double distilled water or deionized water) or salt water (e.g., any type of saltwater wherein the water contains at least some amount of one or more chloride salts; including, but not limited to, natural seawater and artificial seawater). This process can also include a step wherein at least one other reaction product, in addition to the hydrogen gas, is collected from said hydrogen gas generation system. The other reaction product can be a magnesium compound (e.g., an oxide, hydroxide or oxyhydroxide of magnesium), an aluminum compound (e.g., an oxide, hydroxide or oxyhydroxide of aluminum) or a mixture of magnesium and aluminum compounds. These other compounds, once collected, can be sold to help offset the cost of producing hydrogen gas from the process.

In embodiments one, two and three, discussed above, it is possible and many times desirable to use a catalyst as part of the composition, hydrogen gas generation system or process. The catalyst can be supported on a substrate or unsupported. A preferred catalyst is a finely divided carbonyl iron, finely divided ferric oxide, or finely divided ferric-ferrous oxide. Another preferred catalyst is molybdenum or a molybdenum oxide compound (e.g., in the form of a powder).

When both magnesium powder and aluminum powder are used in the composition, hydrogen gas generation system or process, it is preferred to use them in a weight ratio (magnesium/aluminum) of from 0.50/0.50 to 0.25/0.75. It is also sometimes preferred to use a weight ratio of magnesium/aluminum of from 0.40/0.60 to 0.30/0.70.

What is claimed is:

1. A composition for the production of hydrogen gas from water, wherein said composition comprises either:
(A) magnesium powder with a particle size of −50 mesh and a chloride salt; or
(B) magnesium powder with a particle size of −50 mesh, aluminum powder with a particle size of −40 mesh and a chloride salt.

2. A hydrogen gas generation system, wherein said system comprises either:
(A) magnesium powder with a particle size of −50 mesh, a chloride salt and water; or
(B) magnesium powder with a particle size of −50 mesh, aluminum powder with a particle size of −40 mesh, a chloride salt and water.

3. A process for the displacement of hydrogen from water so as to obtain hydrogen gas, comprising the steps:
(a) adding a composition comprising either: (i) magnesium powder with a particle size of −50 mesh and a chloride salt; or (ii) magnesium powder with a particle size of −50 mesh, aluminum powder with a particle size of −40 mesh and a chloride salt; to water to form a hydrogen gas generation system; and
(b) collecting hydrogen gas from said hydrogen gas generation system.

4. The composition of claim 1, wherein said chloride salt is potassium chloride or sodium chloride.

5. The composition of claim 1, wherein said magnesium powder has a particle size of −100 mesh and said aluminum powder, if present, has a particle size of −325 mesh.

6. The hydrogen gas generation system of claim 2, wherein said magnesium powder has a particle size of −100 mesh and said aluminum powder, if present, has a particle size of −325 mesh.

7. The hydrogen gas generation system of claim 2, wherein said chloride salt is potassium chloride or sodium chloride.

8. The hydrogen gas generation system of claim 2, wherein said water is fresh water selected from the group consisting of non-potable water, potable water, distilled water, double distilled water and deionized water.

9. The hydrogen gas generation system of claim 2, wherein said water comprises one or more chloride salts.

10. The process of claim 3, wherein said magnesium powder has a particle size of −100 mesh, said aluminum powder, if present, has a particle size of −325 mesh, said chloride salt is potassium chloride or sodium chloride and said water is fresh water or water that comprises one or more chloride salts.

11. The composition of claim 1, further comprising a catalyst.

12. The composition of claim 11, wherein said catalyst is a finely divided carbonyl iron, finely divided ferric oxide, or finely divided ferric-ferrous oxide.

13. The composition of claim 12, wherein said catalyst is supported on a substrate.

14. The composition of claim 12, wherein said catalyst is unsupported.

15. The composition of claim 1, wherein said composition further comprises molybdenum powder.

16. The composition of claim 1, wherein said composition consists essentially of either:
(A) magnesium powder with a particle size of −50 mesh, molybdenum powder and a chloride salt; or
(B) magnesium powder with a particle size of −50 mesh, aluminum powder with a particle size of −40 mesh, molybdenum powder and a chloride salt.

17. The composition of claim 1, wherein said composition further comprises a molybdenum oxide compound.

18. The composition of claim 1, wherein the weight ratio of magnesium powder to aluminum powder in composition (B) is from 0.50/0.50 to 0.25/0.75.

19. The composition of claim 1, wherein the weight ratio of magnesium powder to aluminum powder in composition (B) is from 0.40/0.60 to 0.30/0.70.

20. The process of claim 3, comprising the additional step of collecting other reaction products, in addition to the hydrogen gas, from said hydrogen gas generation system, said other reaction products comprising compounds of magnesium, compounds of aluminum or mixtures of said compounds.
